(19) United States
(12) Patent Application Publication
(10) Pub. No.: US 2020/0143265 A1
(43) Pub. Date: May 7, 2020

(54) SYSTEMS AND METHODS FOR AUTOMATED CONVERSATIONS WITH FEEDBACK SYSTEMS, TUNING AND CONTEXT DRIVEN TRAINING

(71) Applicant: Conversica, Inc., Foster City, CA (US)

(72) Inventors: Siddhartha Reddy Jonnalagadda, Bothell, WA (US); William Dominic Webb-Purkis, San Francisco, CA (US); Ryan Patrick Arbow, Seattle, WA (US); Shubham Shrestha Agarwal, Seattle, WA (US)

(21) Appl. No.: 16/728,991

(22) Filed: Dec. 27, 2019

Related U.S. Application Data
(63) Continuation-in-part of application No. 16/019,382, filed on Jun. 26, 2018.
Application No. 16/019,382 is a continuation-in-part of application No. 14/604,610, filed on Jan. 23, 2015, now Pat. No. 10,026,037.
Application No. 14/604,610 is a continuation-in-part of application No. 14/604,602, filed on Jan. 23, 2015.
Application No. 14/604,602 is a continuation-in-part of application No. 14/604,594, filed on Jan. 23, 2015.
(60) Provisional application No. 62/786,121, filed on Dec. 28, 2018.
(60) Provisional application No. 62/561,194, filed on Sep. 20, 2017.

(51) Int. Cl. G06N 5/02; G06F 40/30

(52) U.S. Cl. CPC G06N 5/025; G06F 40/30

(57) ABSTRACT

Systems and methods for generating a display of AI interactions in an automated conversation are provided. This display allows for simplified review of conversation flow for a user, and to also enable altering the conversation progression in an intuitive and user friendly manner. Also disclosed is managing AI transactions in the automated conversation. Systems and methods for visualizing trends in the automated conversations is also provided, as is tailoring conversations to a particular target, and provided for automatic question generation in the automated conversation. Response integration of an answer to a question in the automated conversation is also disclosed. Embodiments also disclose a Conversica Score generation and used to tune model performance within the automated conversation. Lastly, in some embodiments, systems and methods are provided for handling feedback in the automated conversation.

### CROSS REFERENCE TO RELATED APPLICATIONS

This continuation-in-part application is a non-provisional and claims the benefit of U.S. provisional application of the same title, U.S. provisional application No. 62/786,121, Attorney Docket No. CVSC-18K-P, filed in the USPTO on Dec. 28, 2018, currently.

This continuation-in-part application also claims the benefit of U.S. application entitled “Systems and Methods for Natural Language Processing and Classification,” U.S. application Ser. No. 16/019,382, Attorney Docket No. CVSC-17A1-US, filed in the USPTO on Jun. 26, 2018, which claims the benefit of U.S. provisional application No. 62/561,194, same title, Attorney Docket No. CVSC-17A-P, filed in the USPTO on Sep. 20, 2017, expired. U.S. application Ser. No. 16/019,382 also is a continuation-in-part application which claims the benefit of U.S. application entitled “Systems and Methods for Configuring Knowledge Sets and AI Algorithms for Automated Message Exchanges,” U.S. application Ser. No. 14/604,610, Attorney Docket No. CVSC-1403, filed in the USPTO on Jan. 23, 2015, now U.S. Pat. No. 10,026,037 issued Jul. 17, 2018. Additionally, U.S. application Ser. No. 16/019,382 claims the benefit of U.S. application entitled “Systems and Methods for Processing Message Exchanges Using Artificial Intelligence,” U.S. application Ser. No. 14/604,602, Attorney Docket No. CVSC-1402, filed in the USPTO on Jan. 23, 2015, and U.S. application entitled “Systems and Methods for Management of Automated Dynamic Messaging,” U.S. application Ser. No. 14/604,594, Attorney Docket No. CVSC-1401, filed in the USPTO on Jan. 23, 2015.

All of the above-listed applications/patents are incorporated herein in their entirety by this reference.

### BACKGROUND

The present invention relates to systems and methods for natural language processing and generation of more “human” sounding artificially generated conversations. Such natural language processing techniques may be employed in the context of machine learned conversation systems. These conversational AIs include, but are not limited to, message response generation, AI assistant performance, and other language processing, primarily in the context of the generation and management of a dynamic conversations. Such systems and methods provide a wide range of business people more efficient tools for outreach, knowledge delivery, automated task completion, and also improve computer functioning as it relates to processing documents for meaning. In turn, such system and methods enable more productive business conversations and other activities with a majority of tasks performed previously by human workers delegated to artificial intelligence assistants.

Artificial Intelligence (AI) is becoming ubiquitous across many technology platforms. AI enables enhanced productivity and enhanced functionality through “smarter” tools. Examples of AI tools include stock managers, chatbots, and voice activated search-based assistants such as Siri and Alexa. With the proliferation of these AI systems, however, come challenges for user engagement, quality assurance and oversight.

When it comes to user engagement, many people do not feel comfortable communicating with a machine outside of certain discrete situations. A computer system intended to converse with a human is typically considered limiting and frustrating. This has manifested in a deep anger many feel when dealing with automated phone systems, or spammed, non-personal emails.

These attitudes persist even when the computer system being conversed with is remarkably capable. For example, many personal assistants such as Siri and Alexa include very powerful natural language processing capabilities; however, the frustration when dealing with such systems, especially when they do not “get it” persists. Ideally an automated conversational system provides more organic sounding messages in order to reduce this natural frustration on behalf of the user. Indeed, in the perfect scenario, the user interfacing with the AI conversation system would be unaware that they are speaking with a machine rather than another human.

In order for a machine to sound more human or organic includes improvements in natural language processing and the generation of accurate, specific and contextual action to meaning rules.

It is therefore apparent that an urgent need exists for advancements in the natural language processing techniques used by AI conversation systems, including include feedback mechanisms to enable functionality that improves over time, as well as easily navigable interfaces for the configuration of context dependent systems, and for easily determining error severity for improved model tuning.

### SUMMARY

To achieve the foregoing and in accordance with the present invention, systems and methods for natural language processing, automated conversations, and enhanced system functionality are provided. Such systems and methods allow for more effective AI operations, improvements to the experience of a conversation target, and increased productivity through AI assistance.

In some embodiments, systems and methods are provided for generating a display of AI interactions in an automated conversation. This display allows for simplified review of conversation flow for a user, and to also enable altering the conversation progression in an intuitive and user friendly manner. This display generation includes creating a series of columns alternating between an AI and a target. The first column is for the AI, and includes a first “engage” node. This then progresses to the possible intents from a response received from the target in the following column. Each node that is populated either progresses to a later node, or includes a termination. The termination response types include stop messaging, not interested, and dissatisfied. In contrast, nodes that indicate a desire to continue contact include contact information provided, confirm interest, further action, no further action and satisfied.

In some embodiments, systems and methods may also be provided for managing AI transactions in the automated conversation. This includes the usage of an interface that allows a user to configure conversation transitions using pull down menus for detected intents and actions that are taken in response to the detection of these intents. Selections for these intents and actions are received from the user. The intents may be combined using Boolean expressions, particularly either an ‘and’ or an ‘or’ expression. These selections are added to the conversation decision system as rules, which may be tested (as concurrent AB testing with earlier rules, comparison of the rule to historical response data to determine actions, applying the rule in real time and comparing the results to expected results, and via measuring the rule against at least one business objective). The rule can be applied to the conversations in real time, thereby allowing for rule impacts to be visualized along with responses the rule is applied to. Rules can be tuned in response to this visualization.

In yet other embodiments, systems and methods for visualizing trends in the automated conversations is provided. In this system, a number of concurrent AI driven artificial conversations are administered in parallel. This may include many thousands or millions of conversations. Responses in the conversations are classified to determine intents, which are then quantified for a given time domain to identify trends in intent and conversation volume from one time domain to the next. These trends are displayed to the user.

In yet other embodiments, the conversation responses may be tailored to the particular target by bucketizing targets of the conversations into categories. Rule effectiveness for achieving a business goal based upon the category of the target is tracked in order to determine the most efficacious rules based upon the given target category. When a new target is received, it can be categorized and only these most efficacious rules pertaining to that target's category may be employed in future conversations. The target categories may include a hot lead, a default, and a lead that requires further action, in some cases.

In other embodiments, systems and methods are provided for automatic question generation in the automated conversation. Initially questions within conversation responses are identified by keyword, syntax analysis, or machine learning algorithms. The identified questions are linked with associated answers, and the questions are clustered by similarity of their associated answers. These question clusters are provided to the user as a frequently asked question.

In other embodiments, automatic question generation may be performed by applying topic modeling to the questions that have been identified to determine a probability of a topic for each question. A master question for each topic is identified as the question with the highest probability for that topic. Then an annotator may be iteratively asked if the master question for a given topic ‘matches’ that of another topic. If so, the topics are merged, and this is repeated until each topic is discrete—not able to be merged further. These final topic groups are clusters that are shown to the annotators, and each question in the cluster is presented to confirm it belongs within the cluster. Questions that no longer belong can be removed to form the final clusters that again are provided to the user as frequently asked questions.

Regardless of method employed to identify the frequently asked questions, the client may also provide a new question to one of the clusters if they desire. The linked question and answer pairs may be approved for the usage in future responses automatically. If no questions are detected originally, or if there are issues linking the question to an answer, human annotation can be requested.

In some embodiments, question response integration in the automated conversation is also disclosed. After a question is identified in the conversation message, for which an answer is known and already approved, the answer is selected based upon topic. Message context for the response is identified by the conversation stage and business objectives. The answers placement in this response is dependent upon this context in combination with the question that was asked, the conversation, client involved, and industry. The response is then generated with this message content and the answer inserted at the answer placement location. The question topic may be inserted as a variable in the response based upon the answer placement.

In other embodiments, a Conversica Score may be generated and used to tune model performance within the automated conversation. This system includes generating a confusion matrix for predicted classifications versus ‘ground truth’ classifications made by a model, as probability of such an event occurring. Weights are then assigned to each of the cells in the matrix responsive to business objectives. The weights are applied and the Conversica score is generated according to the following equation:

Conversica Score=sum_i(weights[i,i]*count[i,i])/sum_i_j(weights[i,j]*count[i,j])

The model may then be tuned by maximizing for the score value during any model training events. In some cases, the ground truth is determined by a human annotator, and the weights are determined based upon expert opinion, or statistical analysis of the monetary cost associated with a misclassification of the type indicated by the particular matrix cell. The weights may be multiplying against the probabilities for the matrix cell in some cases.

Lastly, in some embodiments, systems and methods are provided for handling feedback in the automated conversation. When feedback is received (either as a structured form or via email message) it is assigned to a reviewer and categorized into one of a client error, agree with AI, training required, or future feature. If the categorization is that training is required, then the severity of the error is initially determined, and the corrective action to be taken is determined. This may include altering a knowledge database, rule updating, model versioning, model tuning, or new model generation. The corrective action is then applied, and performance improvement is assessed. Feedback on any of the feedback classifications is provided back to the user. Error severity is determined based upon expert opinion, or via the monetary cost caused by the error.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generation and implementation of messaging conversations, in accordance with some embodiment;

FIG. 2 is an example logical diagram of a dynamic messaging server, in accordance with some embodiment;

FIG. 3 is an example logical diagram of a user interface within the dynamic messaging server, in accordance with some embodiment;

FIG. 4 is an example logical diagram of a message generator within the dynamic messaging server, in accordance with some embodiment;

FIG. 5A is an example logical diagram of a message response system within the dynamic messaging server, in accordance with some embodiment;

FIG. 5B is an example logical diagram of an AI interface, in accordance with some embodiment;

FIG. 5C is an example logical diagram of delivery handler, in accordance with some embodiment;

FIG. 5D is an example logical diagram of a question analytics engine, in accordance with some embodiment;

FIG. 5E is an example logical diagram of a feedback handler, in accordance with some embodiment;

FIG. 5F is an example logical diagram of a severity scoring engine, in accordance with some embodiment;

FIG. 6 is an example flow diagram for a dynamic message conversation, in accordance with some embodiment;

FIG. 7 is an example flow diagram for the process of on-boarding a business actor, in accordance with some embodiment;

FIG. 8 is an example flow diagram for the process of building a business activity such as conversation, in accordance with some embodiment;

FIG. 9 is an example flow diagram for the process of generating message templates, in accordance with some embodiment;

FIG. 10 is an example flow diagram for the process of implementing the conversation, in accordance with some embodiment;

FIG. 11 is an example flow diagram for the process of preparing and sending the outgoing message, in accordance with some embodiment;

FIG. 12 is an example flow diagram for the process of processing received responses, in accordance with some embodiment;

FIG. 13 is an example flow diagram for the process of classification using a knowledge base, in accordance with some embodiment;

FIG. 14 is an example flow diagram for annotation request, in accordance with some embodiment;

FIG. 15 is an example flow diagram for action setting, in accordance with some embodiment;

FIG. 16 is an example flow diagram for AI interaction management, in accordance with some embodiment;

FIG. 17 is an example flow diagram for automated question detection and modeling, in accordance with some embodiment;

FIG. 18 is an example flow diagram for feedback handling, in accordance with some embodiment;

FIG. 19 is an example flow diagram for model tuning by severity, in accordance with some embodiment;

FIGS. 20A and 20B are an example illustrations for screenshots of a user interface for AI conversation management, in accordance with some embodiment; and

FIGS. 21A and 21B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to enhancements to traditional natural language processing techniques and subsequent actions taken by an automated system. While such systems and methods may be utilized with any AI system, such natural language processing particularly excel in AI systems relating to the generation of automated messaging for business conversations such as marketing and other sales functions. While the following disclosure is applicable for other combinations, we will focus upon natural language processing in AI marketing systems as an example, to demonstrate the context within which the enhanced natural language processing excels.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements in natural language processing and actions taken in response to such message exchanges, within conversation systems, and for employment of domain specific assistant systems that leverage these enhanced natural language processing techniques. The goal of the message conversations is to enable a logical dialog exchange with a recipient, where the recipient is not necessarily aware that they are communicating with an automated machine as opposed to a human user. This may be most efficiently performed via a written dialog, such as email, text messaging, chat, etc. However, given the advancement in audio and video processing, it may be entirely possible to have the dialog include audio or video components as well.

In order to effectuate such an exchange, an AI system is employed within an AI platform within the messaging system to process the responses and generate conclusions regarding the exchange. These conclusions include calculating the context of a document, intents, entities, sentiment and confidence for the conclusions. Human operators, through a “training desk” interface, cooperate with the AI to ensure as seamless an experience as possible, even when the AI system is not confident or unable to properly decipher a message, and through message annotation processes. The natural language techniques disclosed herein assist in making the outputs of the AI conversation system more effective, and more ‘human sounding’, which may be preferred by the recipient/target of the conversation.

### I. Dynamic Messaging Systems with Enhanced Natural Language Processing

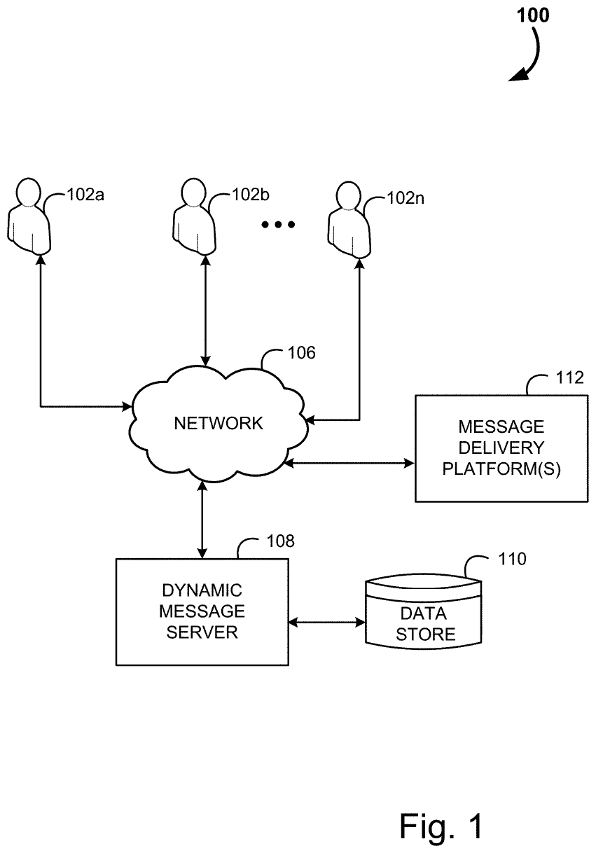

To facilitate the discussion, FIG. 1 is an example logical diagram of a system for generating and implementing messaging conversations, shown generally at 100. In this example block diagram, several users 102a-n are illustrated engaging a dynamic messaging system 108 via a network 106. Note that messaging conversations may be uniquely customized by each user 102a-n in some embodiments. In alternate embodiments, users may be part of collaborative sales departments (or other collaborative group) and may all have common access to the messaging conversations. The users 102a-n may access the network from any number of suitable devices, such as laptop and desktop computers, work stations, mobile devices, media centers, etc.

The network 106 most typically includes the interne but may also include other networks such as a corporate WAN, cellular network, corporate local area network, or combination thereof, for example. The messaging server 108 may distribute the generated messages to the various message delivery platforms 112 for delivery to the individual recipients. The message delivery platforms 112 may include any suitable messaging platform. Much of the present disclosure will focus on email messaging, and in such embodiments the message delivery platforms 112 may include email servers (Gmail, Yahoo, Outlook, etc.). However, it should be realized that the presently disclosed systems for messaging are not necessarily limited to email messaging. Indeed, any messaging type is possible under some embodiments of the present messaging system. Thus, the message delivery platforms 112 could easily include a social network interface, instant messaging system, text messaging (SMS) platforms, or even audio or video telecommunications systems.

One or more data sources 110 may be available to the messaging server 108 to provide user specific information, message template data, knowledge sets, intents, and target information. These data sources may be internal sources for the system's utilization or may include external third-party data sources (such as business information belonging to a customer for whom the conversation is being generated). These information types will be described in greater detail below. This information may be leveraged, in some embodiments, to generate a profile regarding the conversation target. A profile for the target may be particularly useful in a sales setting where differing approaches may yield dramatically divergent outcomes. For example, if it is known that the target is a certain age, with young children, and with an income of $75,000 per year, a conversation assistant for a car dealership will avoid presenting the target with information about luxury sports cars, and instead focus on sedans, SUVs and minivans within a budget the target is likely able to afford. By engaging the target with information relevant to them, and sympathetic to their preferences, the goals of any given conversation are more likely to be met. The external data sources typically relied upon to build out a target profile may include, but are not limited to, credit applications, CRM data sources, public records data sets, loyalty programs, social media analytics, and other “pay to play” data sets, for example.

The other major benefit of a profile for the target is that data that the system “should know” may be incorporated into the conversation to further personalize the message exchange. Information the system “should know” is data that is evident trough the exchange, or the target would expect the AI system would know. Much of the profile data may be public, but a conversation target would feel strange (or even violated) to know that the other party they are communicating with has such a full set of information regarding them. For example, a consumer doesn't typically assume a retailer knows how they voted in the last election, but through an AI conversational system with access to third party data sets, this kind of information may indeed be known. Bringing up such knowledge in a conversation exchange would strike the target as strange, at a minimum, and may actually interfere with achieving the conversation objectives. In contrast, offered information, or information the target assumes the other party has access to, can be incorporated into the conversation in a manner that personalizes the exchange, and makes the conversation more organic sounding. For example if the target mentions having children, and is engaging an AI system deployed for an automotive dealer, a very natural message exchange could include “You mentioned wanting more information on the Highlander SUV. We have a number in stock, and one of our sales reps would love to show you one and go for a test drive. Plus they are great for families. I′m sure your kids would love this car.”

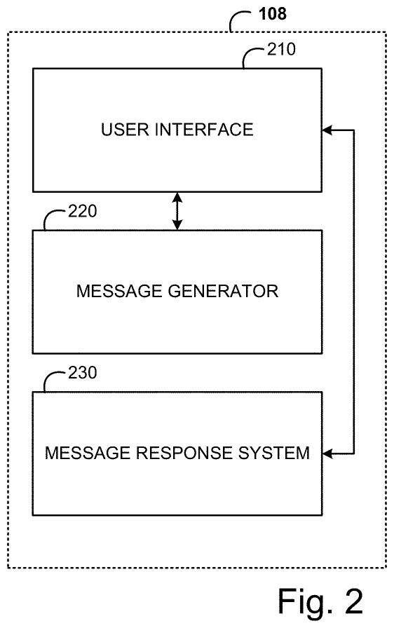

Moving on, FIG. 2 provides a more detailed view of the dynamic messaging server 108, in accordance with some embodiment. The server is comprised of three main logical subsystems: a user interface 210, a message generator 220, and a message response system 230. The user interface 210 may be utilized to access the message generator 220 and the message response system 230 to set up messaging conversations and manage those conversations throughout their life cycle. At a minimum, the user interface 210 includes APIs to allow a user's device to access these subsystems. Alternatively, the user interface 210 may include web accessible messaging creation and management tools.

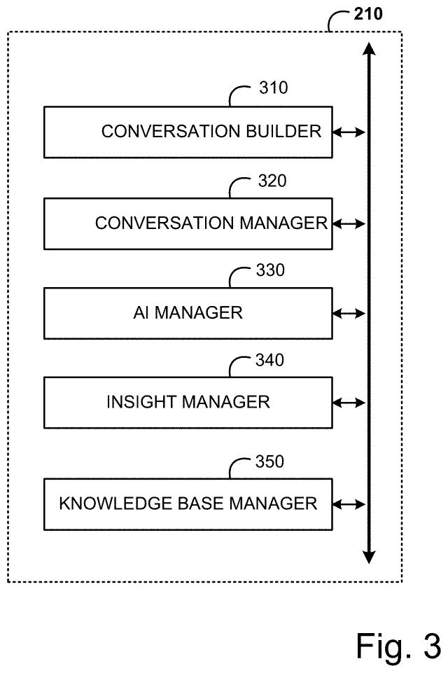

FIG. 3 provides a more detailed illustration of the user interface 210. The user interface 210 includes a series of modules to enable the previously mentioned functions to be carried out in the message generator 220 and the message response system 230. These modules include a conversation builder 310, a conversation manager 320 an AI manager 330, an intent manager 340, and a knowledge base manager 350.

The conversation builder 310 allows the user to define a conversation, and input message templates for each series/exchange within the conversation. A knowledge set and target data may be associated with the conversation to allow the system to automatically effectuate the conversation once built. Target data includes all the information collected on the intended recipients, and the knowledge set includes a database from which the AI can infer context and perform classifications on the responses received from the recipients.

The conversation manager 320 provides activity information, status, and logs of the conversation once it has been implemented. This allows the user 102a to keep track of the conversation's progress, success and allows the user to manually intercede if required. The conversation may likewise be edited or otherwise altered using the conversation manager 320.

The AI manager 330 allows the user to access the training of the artificial intelligence which analyzes responses received from a recipient. One purpose of the given systems and methods is to allow very high throughput of message exchanges with the recipient with relatively minimal user input. To perform this correctly, natural language processing by the AI is required, and the AI (or multiple AI models) must be correctly trained to make the appropriate inferences and classifications of the response message. The user may leverage the AI manager 330 to review documents the AI has processed and has made classifications for.

In some embodiments, the training of the AI system may be enabled by, or supplemented with, conventional CRM data. The existing CRM information that a business has compiled over years of operation is incredibly rich in detail, and specific to the business. As such, by leveraging this existing data set the AI models may be trained in a manner that is incredibly specific and valuable to the business. CRM data may be particularly useful when used to augment traditional training sets, and input from the training desk. Additionally, social media exchanges may likewise be useful as a training source for the AI models. For example, a business often engages directly with customers on social media, leading to conversations back and forth that are again, specific and accurate to the business. As such this data may also be beneficial as a source of training material.

The intent manager 340 allows the user to manage intents. As previously discussed, intents are a collection of categories used to answer some question about a document. For example, a question for the document could include “is the lead looking to purchase a car in the next month?” Answering this question can have direct and significant importance to a car dealership. Certain categories that the AI system generates may be relevant toward the determination of this question. These categories are the ‘intent’ to the question and may be edited or newly created via the intent manager 340. As will be discussed in greater detail below, the generation of questions and associated intents may be facilitated by leveraging historical data via a recommendation engine.

In a similar manner, the knowledge base manager 350 enables the management of knowledge sets by the user. As discussed, a knowledge set is a set of tokens with their associated category weights used by an aspect (AI algorithm) during classification. For example, a category may include “continue contact?”, and associated knowledge set tokens could include statements such as “stop”, “do no contact”, “please respond” and the like.

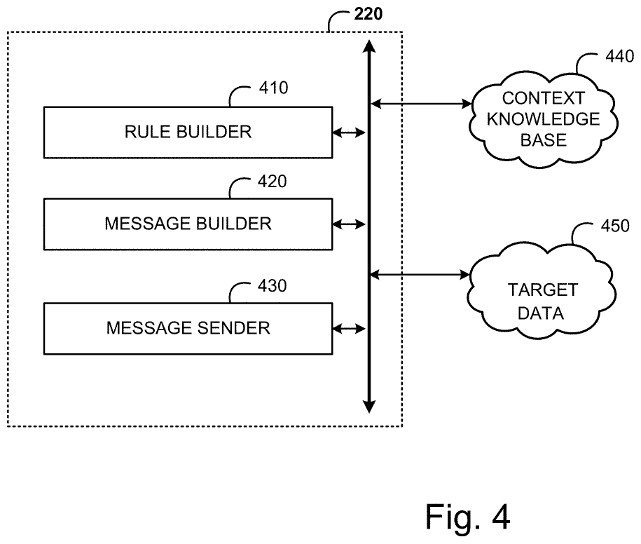

Moving on to FIG. 4, an example logical diagram of the message generator 220 is provided. The message generator 220 utilizes context knowledge 440 and target data 450 to generate the initial message. The message generator 220 includes a rule builder 410 which allows the user to define rules for the messages. A rule creation interface which allows users to define a variable to check in a situation and then alter the data in a specific way. For example, when receiving the scores from the AI, if the intent is Interpretation and the chosen category is ‘good’, then have the Continue Messaging intent return ‘continue’.

The rule builder 410 may provide possible phrases for the message based upon available target data. The message builder 420 incorporates those possible phrases into a message template, where variables are designated, to generate the outgoing message. Multiple selection approaches and algorithms may be used to select specific phrases from a large phrase library of semantically similar phrases for inclusion into the message template. For example, specific phrases may be assigned category rankings related to various dimensions such as “formal vs. informal, education level, friendly tone vs. unfriendly tone, and other dimensions,” Additional category rankings for individual phrases may also be dynamically assigned based upon operational feedback in achieving conversational objectives so that more “successful” phrases may be more likely to be included in a particular message template. Phrase package selection will be discussed in further detail below. The selected phrases incorporated into the template message is provided to the message sender 430 which formats the outgoing message and provides it to the messaging platforms for delivery to the appropriate recipient.

Feedback may be collected from the conversational exchanges, in many embodiments. For example if the goal of a given message exchange is to set up a meeting, and the target agrees to said meeting, this may be counted as successful feedback. However, it may also be desirable to collect feedback from external systems, such as transaction logs in a point of sales system, or through records in a CRM system.

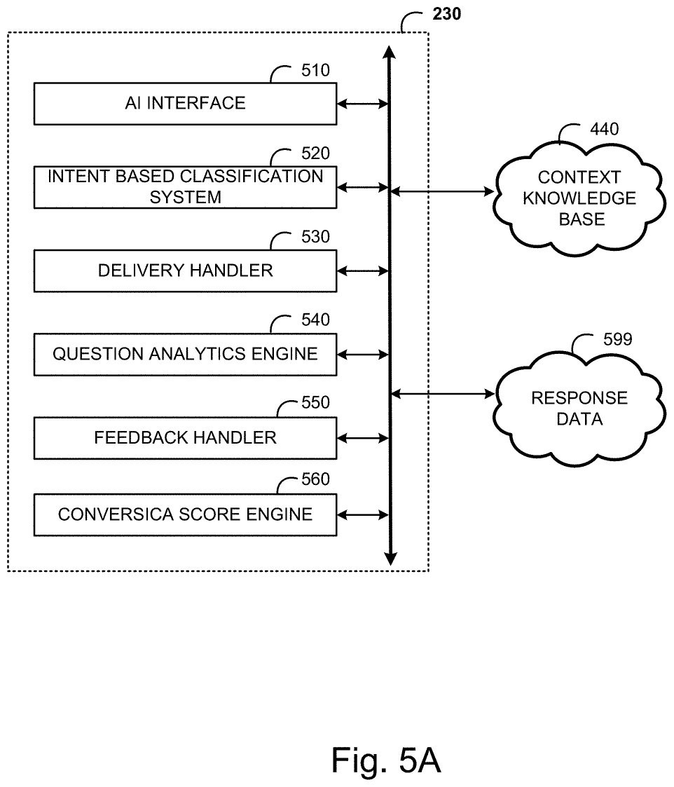

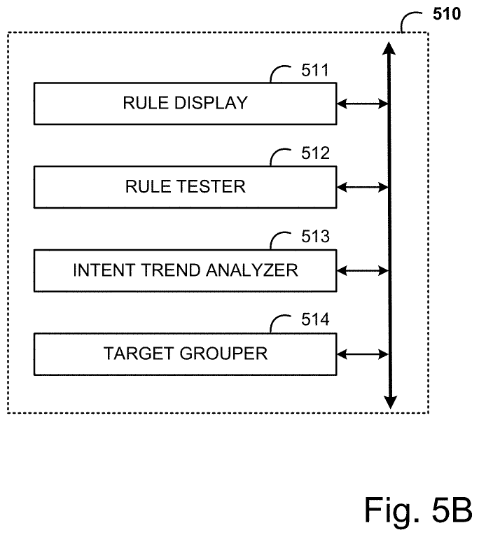

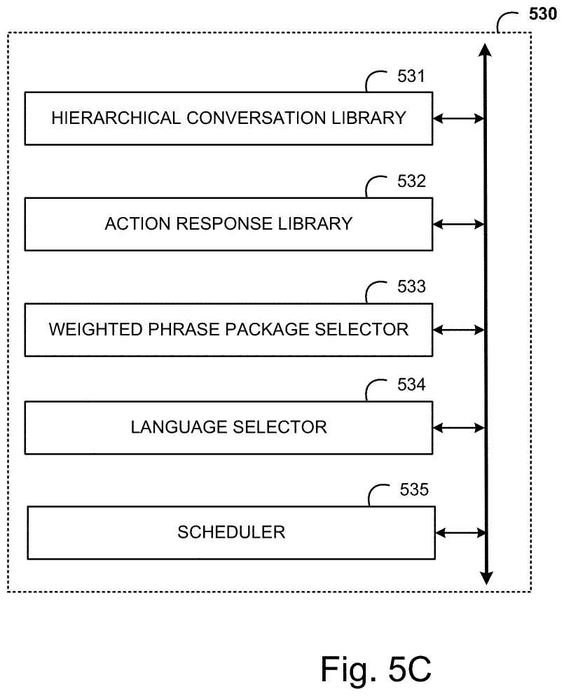

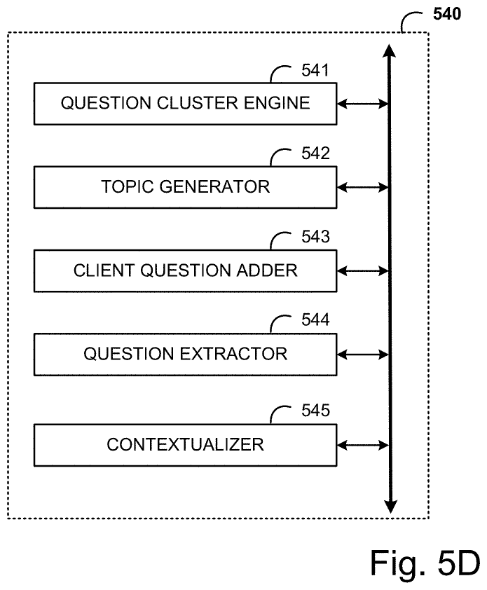

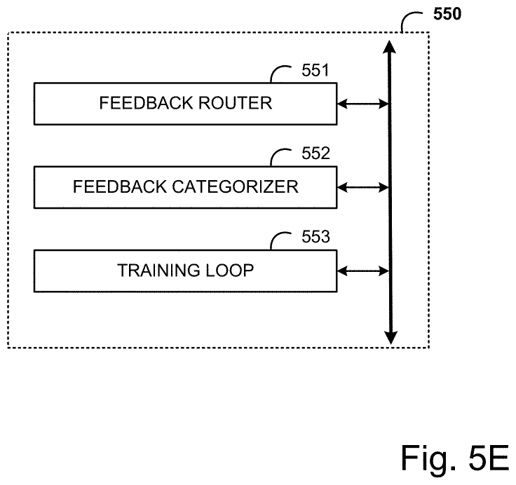

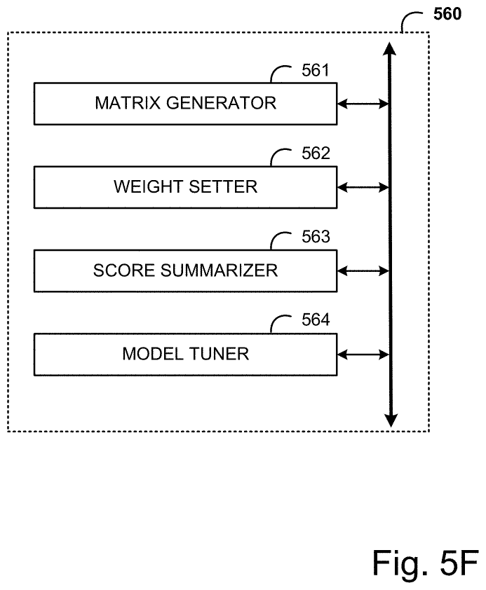

FIG. 5A is an example logical diagram of the message response system 230. In this example system, the context knowledge base 440 is utilized in combination with response data 599 received from the person being messaged (the target or recipient). The AI interface 510 receives the response data 599 and provides it to the other system components for processing. This processing may include a suite of tools that enable classification of the messages using machine learned models, and based on the classifications generated by the AI and classification tools 520, target objectives may be updated and the subsequent actions to be taken may be determined. The AI interface in addition to being in communication with the other system components, also includes the functionality of testing rules, and displaying trend information to the user to assist in improving the system's operation. A scheduler and message delivery handler 530 may coordinate the execution of these determined activities, and interface with third party email systems to deliver response messages.

The message delivery handler 530 enables not only the delivery of the generated responses, but also may effectuate the additional actions beyond mere response delivery. The message delivery handler 530 may include phrase selections, contextualizing the response by historical activity, through language selection, and execute additional actions like status updates, appointment setting, and the like.

As noted before, all machine learning NLP processes are exceptionally complicated and subject to frequent failure. Even for very well trained models, jargon and language usage develops over time, and differs between different contextual situation, thereby requiring continual improvement of the NLP systems to remain relevant and of acceptable accuracy. The following additional components are designed to address this need for continual system improvement. For example, a question analytics engine 540 may automatically identify questions that occur in a conversation exchange. These questions may be clustered and used to train models to address them. A feedback handler 550 is involved in resolving feedback that is provided by a user or client of the system. A severity score (Conversica Score) engine 560 is capable of determining severity of errors and weighting model tuning corrections based upon the severity of a given mistake. This enables very “bad” mistakes from repeating in the future, and indeed is similar to how a human actually learns.

Many of the aforementioned system components benefit from collecting detailed information from existing external systems within an organization (or more globally). A scraper (not illustrated) enables the collection of these data streams to allow these systems to operate more effectively.

Turning to FIG. 5B, the AI interface 510 is provided in greater detail. As noted, the AI interface 510 allows the receipt of a conversation message, but also allows for rule display 511, rule testing 512 and trend analysis 513. The target grouper 514 collects together conversation targets (those the system is communicating with) and aggregates the conversation information involved for accurately illustrating the trend information.

Although not displayed in significant detail, the intent based classification system 520 is central to the systems operation. Prior patent disclosures have already been filed regarding this component's operation, and in the interest of brevity, many of these discussions will be simplified or omitted. It should be noted that these other disclosures are referenced and therefore incorporated in full.

Prior to any processing, the response 599 may be subject to any number of preprocessing activities, such as parsing, normalization and error corrections. For example, a parser (not illustrated) could consume the raw message and splits it into multiple portions, including differentiating between the salutation, reply, close, signature and other message components, for example. Likewise, a tokenizer may break the response into individual sentences and n-grams.

After any such pre-processing, a neural encoder processes the response to define response level intents, sentence level intents, entity recognition and identifies similarity between sentences. Traditionally, it has proven difficult to perform inferencing and reasoning only based on conversation inputs primarily based on neural encoding of text or speech.

The present system encodes natural language as intents and named entities and performs natural language generation based on the value of intents and entities. Particularly, an end-end neural approach is used where multiple components are stacked within a single deep neural network. These components include an encoder, a reasoner and a decoder. This differs from traditional AI systems which usually use a single speech recognition model, word-level analytics, syntactical parsing, information extractors, application reasoning, utterance planning, syntactic realization, text generation and speech synthesis.

In the present neural encoder, the encoding portion represents the natural language inputs and knowledge as dense, high-dimensional vectors using embeddings, such as dependency-based word embedding and bilingual word embeddings, as well as word representations by semi-supervised learning, semantic representations using conventional neural networks for web search, and parsing of natural scenes and natural language using recursive neural networks.

The reasoner portion of the neural encoder classifies the individual instance or sequence of these resulting vectors into a different instance or sequence typically using supervised approaches such as convolutional networks (for sentence classification) and recurrent networks (for the language model) and/or unsupervised approaches such as generative adversarial networks and auto-encoders (for reducing the dimensionality of data within the neural networks).

Lastly, the decoders of the neural encoder converts the vector outputs of the reasoner functions into symbolic space from which encoders originally created the vector representations. In some embodiments the neural encoder may include three functional tasks: natural language understanding (including intent classification and named entity recognition), inference (which includes learning policies and implementation of these policies appropriate to the objective of the conversation system using reinforcing learning or a precomputed policy), and natural language generation (by taking into account an action/decision made based upon the intent and incorporating AI models for emotion and knowledge sets).

The neural encoder accomplishes these tasks by automatically deriving a list of intents that that describe a conversational domain such that for every response from the user, the conversational AI system is able to predict how likely the user wanted to express intent, and the AI agent's policy can be evaluated using the intents and corresponding entities in the response to determine the agent's action. This derivation of intents uses data obtained from many enterprise assistant conversation flows. Each conversation flow was designed based on the reason for communication, the targeted goal and objectives, and key verbiage from the customer to personalize the outreach. These conversation flows are subdivided by their business functions (e.g., sales assistants selling automobiles, technology products, financial products and other products, service assistants, finance assistants, customer success assistants, collections assistants, recruiting assistants, etc.).

The response 599, as discussed, is natural language text or speech from the human to AI. The neural encoding network uses word embedding models first to encode each token into a vector in a dense high-dimensional vector space. The network is extended to also represent sentences and paragraphs of the response in the vector space. These encodings are passed to a set of four models: named entities extraction, a recurrent neural network (RNN) classifying intents at paragraph-level, and a different recurrent neural network which uses the outputs of neural encoder and classifies the individual sentences into intents. The sentence-level intents and paragraph-level intents share the taxonomy but have a distinct set of labels. Fourth, a K-nearest neighbor algorithm is used on sentence representation to group semantically identical (or similar) sentences. When a cluster of semantically similar groups is big enough, the corresponding RNN model is trained via a trainer for the groups and creates a new sentence intent RNN network and add it the set of sentence intents if bias and variance are low.

The outputs of each of the models represent the state of the environment is shared with the agent in a reinforcement learning setting. The agent applies the policy to optimize a reward and decide upon an action. If the action is not inferred with a suitable threshold of confidence, an annotation platform requests annotation of sentence intents using active learning.

Moving on, FIG. 5C provides an example delivery handler 530, which is presented in greater detail. The message delivery handler 530 receives output from the earlier components and performs its own processing to arrive at the final outgoing message. The message delivery handler 530 may include a hierarchical conversation library 531 for storing all the conversation components for building a coherent message. The hierarchical conversation library 531 may be a large curated library, organized and utilizing multiple inheritance along a number of axes: organizational levels, access-levels (rep−>group−>customer−>public). The hierarchical conversation library 531 leverages sophisticated library management mechanisms, involving a rating system based on achievement of specific conversation objectives, gamification via contribution rewards, and easy searching of conversation libraries based on a clear taxonomy of conversations and conversation trees.

In addition to merely responding to a message with a response, the message delivery handler 530 may also include a set of actions that may be undertaken linked to specific triggers, these actions and associations to triggering events may be stored in an action response library 532. For example, a trigger may include “Please send me the brochure.” This trigger may be linked to the action of attaching a brochure document to the response message, which may be actionable via a webhook or the like. The system may choose attachment materials from a defined library (SalesForce repository, etc.), driven by insights gained from parsing and classifying the previous response, or other knowledge obtained about the target, client, and conversation. Other actions could include initiating a purchase (order a pizza for delivery for example) or pre-starting an ancillary process with data known about the target (kick of an application for a car loan, with name, etc. already pre-filled in for example). Another action that is considered is the automated setting and confirmation of appointments.

The message delivery handler 530 may have a weighted phrase package selector 563 that incorporates phrase packages into a generated message based upon their common usage together, or by some other metric. Lastly, the message delivery handler 530 may operate to select which language to communicate using a language selector 534. Rather than perform classifications using full training sets for each language, as is the traditional mechanism, the systems leverage dictionaries for all supported languages, and translations to reduce the needed level of training sets. In such systems, a primary language is selected, and a full training set is used to build a model for the classification using this language. Smaller training sets for the additional languages may be added into the machine learned model. These smaller sets may be less than half the size of a full training set, or even an order of magnitude smaller. When a response is received, it may be translated into all the supported languages, and this concatenation of the response may be processed for classification. The flip side of this analysis is the ability to alter the language in which new messages are generated. For example, if the system detects that a response is in French, the classification of the response may be performed in the above-mentioned manner, and similarly any additional messaging with this contact may be performed in French.

Determination of which language to use is easiest if the entire exchange is performed in a particular language. The system may default to this language for all future conversation. Likewise, an explicit request to converse in a particular language may be used to determine which language a conversation takes place in. However, when a message is not requesting a preferred language, and has multiple language elements, the system may query the user on a preferred language and conduct all future messaging using the preferred language.

A scheduler 535 used rules for messaging timing and learned behaviors in order to output the message at an appropriate time. For example, when emailing, humans generally have a latency in responding that varies from a few dozen minutes to a day or more. Having a message response sent out too quickly seems artificial. A response exceeding a couple of days, depending upon the context, may cause frustration, irrelevance, or may not be remembered by the other party. As such, the scheduler 535 aims to respond in a more ‘human’ timeframe and is designed to maximize a given conversation objective.

FIG. 5D provides a question analytics engine 540, which is capable of automatically identifying question clusters in conversation exchanges for the purpose of improving the system's ability to respond to these events. This can be particularly effective in the automated generation of a Frequently Asked Questions Assistant (FAQAA). The generation and answering of a FAQ is an arduous task for many small to midsized companies. Additionally, even when these processes are undertaken the results/compiled questions may not be actually relevant to a potential business lead/target. A question clustering engine 541 is capable of question detection by identifying pronunciation indicators (?), as well as the presence of question related words (e.g., who, what, why, where, when and how).

Once the questions have been thus identified, the questions may be clustered into a set number of categories. In some embodiments, the system clusters virtually and question into one of eleven categories, as empirically a corpus of over 5000 questions was analyzed and it was identified that 11 clusters were sufficient to answer them all. In order to complete the clustering, a topic generator 542 uses semantic analysis (as discussed above) to determine the semantic topic the question relates to. Questions with the same (or similar) topic are thus clustered. Generally, there are significantly more topics identified than categories. In the above empirical example, the over 5000 questions resulted in upwards of 300 topics. Examples of this would include the following two sentences that are in the same topic “Can you send me that information by email?” and “Can you send me that quote via email?” In contrast, “Can I get more information?” may not be in the same topic, but belong to the same category.

After the questions have been determined and clustered, the client question adder 543 presents the analysis of the question clusters found to the client for review and approval. This system component may also enable the client to directly add questions to a cluster, if desired.

The question extractor 544 identifies when in the past a representative answered a question in the cluster. In the future, when the same or similarly clustered questions are asked, this allows the system to apply the extracted data in a question-answer pair (after client approval, in some cases). Lastly, if there is no instance where the answer to the question can be adequately extracted, or if the system is having an issue determining what category the question belongs in, a contextualizer 545 may send the suspect question to a training desk for manual review. The results from the human input are then used to update the clustering machine learning algorithms.

FIG. 5E provides greater detail into the feedback handler system 550, which is a central component of addressing concerns by a client regarding an action taken by the system. A feedback router 551 receives feedback regarding AI miss-classification from a client via an email, or a structured form that allows for selection of the issue from a dropdown menu or similar interface. Feedback in text format/email is routed to a reviewer initially, due to the sensitivity of feedback handling. Regardless of how the feedback is received an event case is opened for the feedback.

The next couple steps involve a degree of human interaction, including assignment of the case to a team member, manual review and determination of what “train as” category the feedback belongs to. The feedback categorizer 552 assists in recording this decision process. The categorization is into four groups. The first situation is that the client is incorrect and that the AI classification was in fact correct. The submission in this circumstance is reviewed again, and a tailored comment is prepared and provided to the client explaining how the AI was being correct.

The second grouping is for the client to agree with the AI's classification, which is correct. Such an event may occur when the client wants to provide feedback in addition to the classification in the form of comments or wants to “like” the action the AI took.

The next grouping is a future feature, which is some capability the system will hopefully have in the future, but is not currently trained for, or otherwise capable of completing. The submission in this circumstance is reviewed again, and a list of this feature request is kept. This feedback is useful in determining what aspects of the system should be further developed. Additionally, a tailored comment is prepared and provided to the client explaining how the AI is currently unable to complete this action/classification, but that such a feature will be expected in subsequent versions of the AI system.

Lastly, the feedback may be categorized as needing to perform AI training (the AI was in error and the capability exists in current feature sets). In this case the feedback is provided to the training loop 553 where the correct action for the input is determined, often through human annotation. The severity of the mistake is next identified. This may include a “gut check” by the reviewer, or a process more akin to the severity score that will be discussed in considerable detail below. Additionally, the confidence of the finding may be used to augment the severity finding. For example, using the below severity score matrix (discussed below in greater detail), mistaking a ‘Do not Contact’ classification for ‘Provide more information’ is a fairly “bad” mistake. However, this mistake would be considered even worse, from a model training perspective if the model was very sure of its erroneous classification (e.g., 95% confident) as this indicates that something deeply rooted in the model is inaccurate.

The severity level of the mistake, and the related conversation exchanges are provided to a data science team for assessment of the issue, and tuning of the model to address the issue. Generally a severe mistake may involve releasing a new model or reverting to an earlier version of the model that is not similarly corrupted. When feasible, the model may instead be updated to eliminate the error if the cause is relatively straight forward. In addition to taking corrective action on the model(s), the client is provided a confirmation of the issue and an expected percentage improvement the feedback produced in the model.

FIG. 5F provides greater detail into the Conversica Score™ engine 560 which derives a metric to determine the severity of a system mishap in order to properly weight corrective actions. The severity determination starts with the generation of a confusion matrix of classifications by a matrix generator 561. The model predictions are placed on one side of the matrix, and the “ground truth” as determined by annotations are provided along the other matrix axis. This results with the diagonal from the top left to the bottom right indicating incidences of correct classifications. The Conversica Score is derived from the confusion matrix by assigning weights to the errors based upon the expected business impact of such a miss-classification. In some embodiments, these weights are the quantitative monetary cost of an incorrect classification. In other embodiments, the client may have additional input on the proper weighting of misclassifications. The weight setter 562 applies these weights to the errors that have occurred, resulting in a business weighted accuracy matrix.

A score summarizer 563 distills the matrix into a single score, the Conversica Score, which provides an indication of how well a model performs, in light of the business goals. In some example, the matrix of weights could look as below:
weights=[
[1.00, 0.25, 0.25, 1.00, 1.00], #Action 1
[0.75, 1.00, 0.25, 1.00, 1.00], #Action 2
[1.00, 0.33, 1.00, 1.00, 0.67], #Action 3
[1.00, 0.67, 0.50, 1.00, 0.33], #Action 4
[1.00, 0.58, 0.42, 0.25, 1.00] #Action 5
]

Similarly, the matrix of counts could look as below:
counts=[
[162, 4, 10, 0, 20], #Action 1
[12, 8, 4, 0, 6], #Action 2
[10, 2, 582, 4, 30], #Action 3
[0, 0, 4, 50, 2], #Action 4
[24, 0, 40, 2, 104] #Action 5
]

The formula for Conversica Score is given below:

Conversica Score=sum_i(weights[i,i]*count[i,i])/sum_i_j(weights[i,j]*count[i,j])

Lastly, a model tuner 564, uses the score when updating the models. For example, the score may be optimized for when performing a tuning exercise, rather than merely attempting to reduce error rates. For example, if a particular model update increases misclassification of a “low severity” mix-up, then this may be an acceptable update as long as more ‘egregious’ misclassification are marginally reduced, for example.

### II. Methods

Now that the systems for dynamic messaging and natural language processing techniques have been broadly described, attention will be turned to processes employed to perform AI driven conversations with attendant actions and enhanced functionalities.

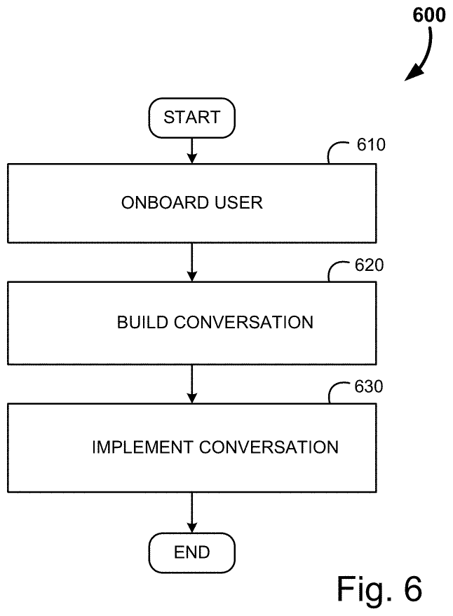

In FIG. 6 an example flow diagram for a dynamic message conversation is provided, shown generally at 600. The process can be broadly broken down into three portions: the on-boarding of a user (at 610), conversation generation (at 620) and conversation implementation (at 630). The following figures and associated disclosure will delve deeper into the specifics of these given process steps.

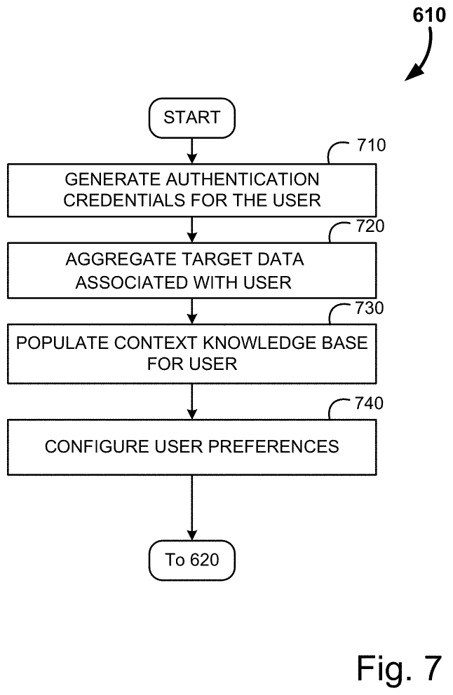

FIG. 7, for example, provides a more detailed look into the on-boarding process, shown generally at 610. Initially a user is provided (or generates) a set of authentication credentials (at 710). This enables subsequent authentication of the user by any known methods of authentication. This may include username and password combinations, biometric identification, device credentials, etc.

Next, the target data associated with the user is imported, or otherwise aggregated, to provide the system with a target database for message generation (at 720). Likewise, context knowledge data may be populated as it pertains to the user (at 730). Often there are general knowledge data sets that can be automatically associated with a new user; however, it is sometimes desirable to have knowledge sets that are unique to the user's conversation that wouldn't be commonly applied. These more specialized knowledge sets may be imported or added by the user directly.

Lastly, the user is able to configure their preferences and settings (at 740). This may be as simple as selecting dashboard layouts, to configuring confidence thresholds required before alerting the user for manual intervention.

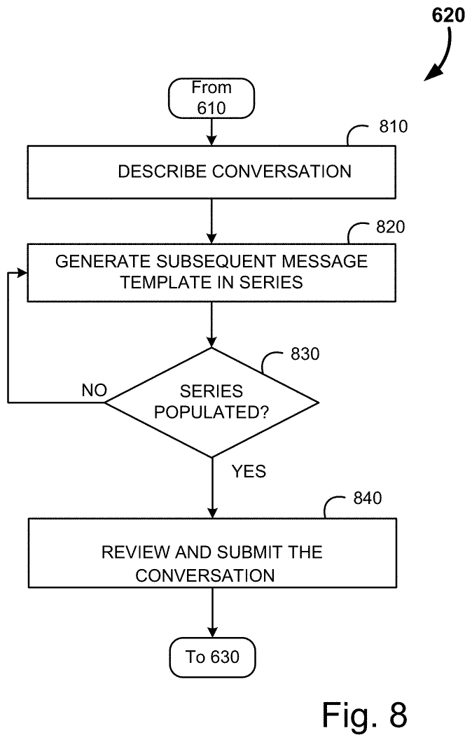

Moving on, FIG. 8 is the example flow diagram for the process of building a conversation, shown generally at 620. The user initiates the new conversation by first describing it (at 810). Conversation description includes providing a conversation name, description, industry selection, and service type. The industry selection and service type may be utilized to ensure the proper knowledge sets are relied upon for the analysis of responses.

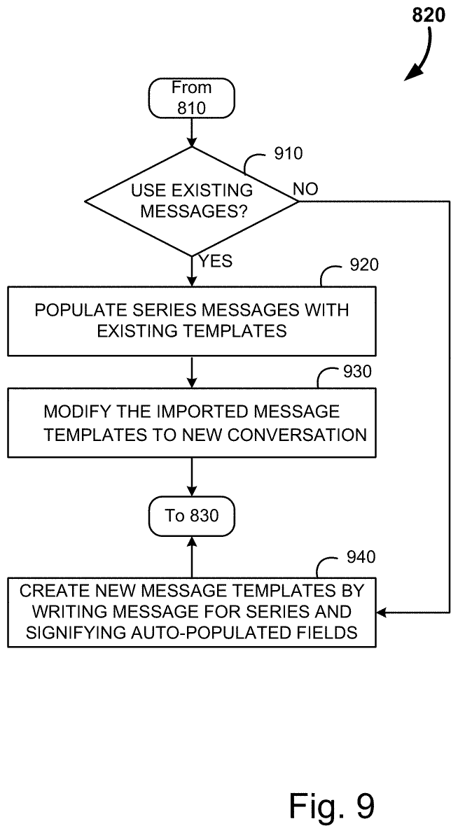

After the conversation is described, the message templates in the conversation are generated (at 820). If the series is populated (at 830), then the conversation is reviewed and submitted (at 840). Otherwise, the next message in the template is generated (at 820). FIG. 9 provides greater details of an example of this sub-process for generating message templates. Initially the user is queried if an existing conversation can be leveraged for templates, or whether a new template is desired (at 910).

If an existing conversation is used, the new message templates are generated by populating the templates with existing templates (at 920). The user is then afforded the opportunity to modify the message templates to better reflect the new conversation (at 930). Since the objectives of many conversations may be similar, the user will tend to generate a library of conversations and conversation fragments that may be reused, with or without modification, in some situations. Reusing conversations has time saving advantages, when it is possible.

However, if there is no suitable conversation to be leveraged, the user may opt to write the message templates from scratch using the Conversation Editor (at 940). When a message template is generated, the bulk of the message is written by the user, and variables are imported for regions of the message that will vary based upon the target data. Successful messages are designed to elicit responses that are readily classified. Higher classification accuracy enables the system to operate longer without user interference, which increases conversation efficiency and user workload.

Messaging conversations can be broken down into individual objectives for each target. Designing conversation objectives allows for a smoother transition between messaging series. Table 1 provides an example set of messaging objectives for a sales conversation.

TABLE 1
Template Objectives

| Series | Objective |
|---|---|
| 1 | Verify Email Address |
| 2 | Obtain Phone Number |
| 2 | Introduce Sales Representative |
| 3 | Verify Rep Follow-Up |

Likewise, conversations can have other arbitrary set of objectives as dictated by client preference, business function, business vertical, channel of communication and language. Objective definition can track the state of every target. Inserting personalized objectives allows immediate question answering at any point in the lifecycle of a target. The state of the conversation objectives can be tracked individually as shown below in reference to Table 2.

TABLE 2
Objective tracking

| Target | Conversation | | | | |
|---|---|---|---|---|---|
| ID | ID | Objective | Type | Pending | Complete |
| 100 | 1 | Verify Email Address | Q | 1 | 1 |
| 100 | 1 | Obtain Phone Number | Q | 0 | 1 |
| 100 | 1 | Give Location Details | I | 1 | 0 |
| 100 | 1 | Verify Rep Follow-Up | Q | 0 | 0 |

Table 2 displays the state of an individual target assigned to conversation 1, as an example. With this design, the state of individual objectives depends on messages sent and responses received. Objectives can be used with an informational template to make a series transition seamless. Tracking a target's objective completion allows for improved definition of target's state, and alternative approaches to conversation message building. Conversation objectives are not immediately required for dynamic message building implementation but become beneficial soon after the start of a conversation to assist in determining when to move forward in a series.

Dynamic message building design depends on ‘message building’ rules in order to compose an outbound document. A Rules child class is built to gather applicable phrase components for an outbound message. Applicable phrases depend on target variables and target state.

To recap, to build a message, possible phrases are gathered for each template component in a template iteration. In some embodiment, a single phrase can be chosen randomly from possible phrases for each template component. Alternatively, as noted before, phrases are gathered and ranked by “relevance”. Each phrase can be thought of as a rule with conditions that determine whether or not the rule can apply and an action describing the phrase's content.

Relevance is calculated based on the number of passing conditions that correlate with a target's state. A single phrase is selected from a pool of most relevant phrases for each message component. Chosen phrases are then imploded to obtain an outbound message. Logic can be universal or data specific as desired for individual message components.

Variable replacement can occur on a per phrase basis, or after a message is composed. Post message-building validation can be integrated into a message-building class. All rules interaction will be maintained with a messaging rules model and user interface.

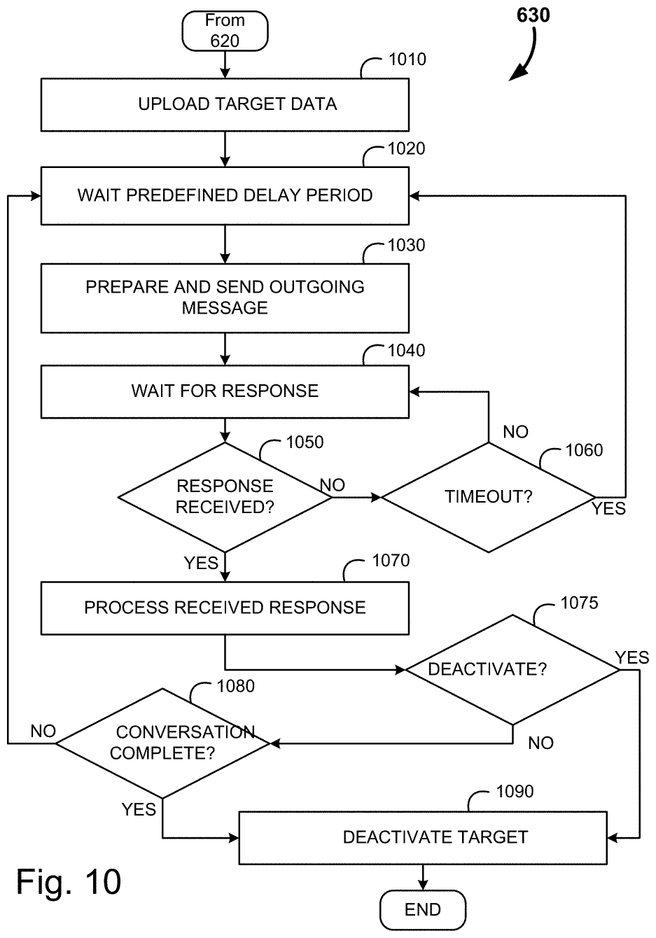

Once the conversation has been built out it is ready for implementation. FIG. 10 is an example flow diagram for the process of implementing the conversation, shown generally at 630. Here the lead (or target) data is uploaded (at 1010). Target data may include any number of data types, but commonly includes names, contact information, date of contact, item the target was interested in (in the context of a sales conversation), etc. Other data can include open comments that targets supplied to the target provider, any items the target may have to trade in, and the date the target came into the target provider's system. Often target data is specific to the industry, and individual users may have unique data that may be employed.

An appropriate delay period is allowed to elapse (at 1020) before the message is prepared and sent out (at 1030). The waiting period is important so that the target does not feel overly pressured, nor the user appears overly eager. Additionally, this delay more accurately mimics a human correspondence (rather than an instantaneous automated message). Additionally, as the system progresses and learns, the delay period may be optimized by a cadence optimizer to be ideally suited for the given message, objective, industry involved, and actor receiving the message.

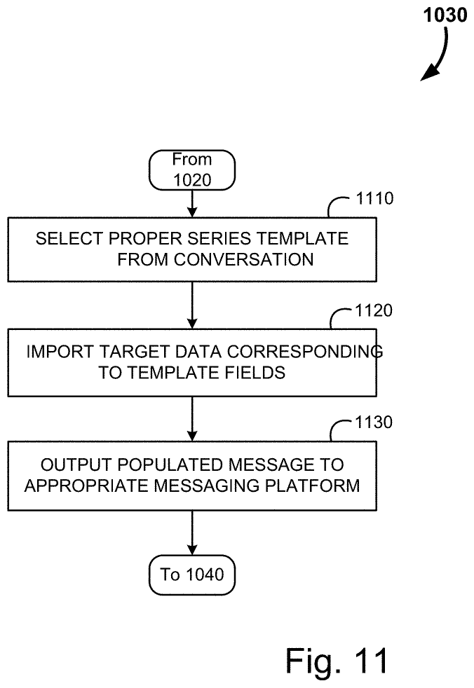

FIG. 11 provides a more detailed example of the message preparation and output. In this example flow diagram, the message within the series is selected based upon which objectives are outstanding (at 1110). Typically, the messages will be presented in a set order; however, if the objective for a particular target has already been met for a given series, then another message may be more appropriate. Likewise, if the recipient didn't respond as expected, or not at all, it may be desirous to have alternate message templates to address the target most effectively.

After the message template is selected from the series, the target data is parsed through, and matches for the variable fields in the message templates are populated (at 1120). Variable filed population, as touched upon earlier, is a complex process that may employ personality matching, and weighting of phrases or other inputs by success rankings. These methods will also be described in greater detail when discussed in relation to variable field population in the context of response generation. Such processes may be equally applicable to this initial population of variable fields.

In addition, or alternate to, personality matching or phrase weighting, selection of wording in a response could, in some embodiments, include matching wording or style of the conversation target. People, in normal conversation, often mirror each other's speech patterns, mannerisms and diction. This is a natural process, and an AI system that similarly incorporates a degree of mimicry results in a more ‘humanlike’ exchange.

Additionally, messaging may be altered by the class of the audience (rather than information related to a specific target personality). For example, the system may address an enterprise customer differently than an individual consumer. Likewise, consumers of one type of good or service may be addressed in subtly different ways than other customers. Likewise, a customer service assistant may have a different tone than an UR assistant, etc.

The populated message is output to the communication channel appropriate messaging platform (at 1130), which as previously discussed typically includes an email service, but may also include SMS services, instant messages, social networks, audio networks using telephony or speakers and microphone, or video communication devices or networks or the like. In some embodiments, the contact receiving the messages may be asked if he has a preferred channel of communication. If so, the channel selected may be utilized for all future communication with the contact. In other embodiments, communication may occur across multiple different communication channels based upon historical efficacy and/or user preference. For example, in some particular situations a contact may indicate a preference for email communication. However, historically, in this example, it has been found that objectives are met more frequently when telephone messages are utilized. In this example, the system may be configured to initially use email messaging with the contact, and only if the contact becomes unresponsive is a phone call utilized to spur the conversation forward. In another embodiment, the system may randomize the channel employed with a given contact, and over time adapt to utilize the channel that is found to be most effective for the given contact.

Returning to FIG. 10, after the message has been output, the process waits for a response (at 1040). If a response is not received (at 1050) the process determines if the wait has been timed out (at 1060). Allowing a target to languish too long may result in missed opportunities; however, pestering the target too frequently may have an adverse impact on the relationship. As such, this timeout period may be user defined and will typically depend on the communication channel. Often the timeout period varies substantially, for example for email communication the timeout period could vary from a few days to a week or more. For real-time chat communication channel implementations, the timeout period could be measured in seconds, and for voice or video communication channel implementations, the timeout could be measured in fractions of a second to seconds. If there has not been a timeout event, then the system continues to wait for a response (at 1050). However, once sufficient time has passed without a response, it may be desirous to return to the delay period (at 1020) and send a follow-up message (at 1030). Often there will be available reminder templates designed for just such a circumstance.

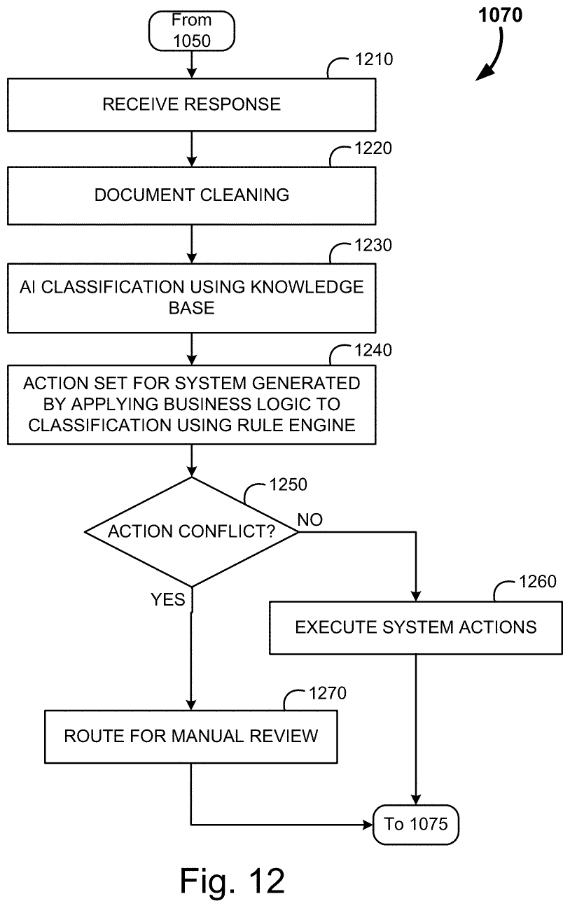

However, if a response is received, the process may continue with the response being processed (at 1070). This processing of the response is described in further detail in relation to FIG. 12. In this sub-process, the response is initially received (at 1210) and the document may be cleaned (at 1220). For example, for an email, adapters may exist for the subject and body of the response, often a number of elements need to be removed, including the original message, HTML encoding for HTML style responses, enforce UTF-8 encoding so as to get diacritics and other notation from other languages, and signatures so as to not confuse the AI. An initial step of the document preprocessing/cleaning process is the parsing of the document into constituent portions. As discussed previously, this may include breaking the raw text of the message into a salutation, body/reply, close, signature and other category. This process includes the removal of outgoing message components, preprocessing text and build features, as previously discussed, and asking for predictions.

The body portion of the response may be split into individual sentences by a sentence splitter. This is performed because generally each sentence of a conversation includes a separate/discrete idea or intention. By separating each sentence the risk of token contamination between the sentences is reduced.

The documents may further be processed through lemmatization, the creation of n-grams, noun-phrase identification, and extraction of out-of-office features. Each of these steps may be considered a feature extraction of the document. Historically, extractions have been combined in various ways, which results in an exponential increase in combinations as more features are desired. In response, the present method performs each feature extraction in discrete steps (on an atomic level) and the extractions can be “chained” as desired to extract a specific feature set.

Returning to FIG. 12, after document cleaning, the document is then provided to the AI platform for classification using the knowledge sets/base (at 1230). For the purpose of this disclosure, a “knowledge set” is a corpus of domain specific information that may be leveraged by the machine learned classification models. The knowledge sets may include a plurality of concepts and relationships between these concepts. It may also include basic concept-action pairings. The AI Platform will apply large knowledge sets to classify ‘Continue Messaging’, ‘Do Not Email’ and ‘Send Alert’ insights. Additionally, various domain specific ‘micro-insights’ can use smaller concise knowledge sets to search for distinct elements in responses.

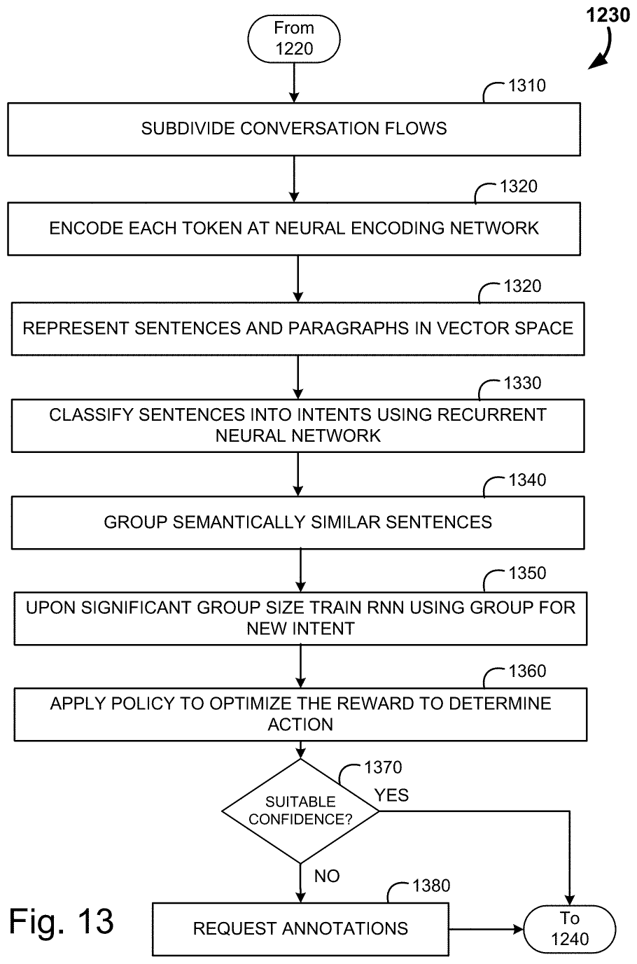

FIG. 13 provides a more detailed view of the classification step 1230. As previously touched upon, this includes subdividing the conversation flows (at 1305) based upon the reason for communication, target goal and objective of the conversation, and sets of key verbiage supplied by the customer to help personalize the outreach effort. Conversation flows may then be further subdivided based upon their business function.

Subsequently, each token of the response is encoded at the neural encoding network (at 1310). The neural encoding network may employ word embedding models to encode each token into a vector in a dense high-dimensional vector space (e.g., 300 or more dimensions). Likewise, sentences and paragraphs may be likewise encoded in the vector space (at 1320). These encodings are then provided to four models, the first may include extraction of name entities across all the sentences. The system may also perform extraction of redact information, as needed. For example, given the importance of privacy regulations in modern business, certain information that is deemed “personally identifiable information” (PII) may be identified within the named entities and redacted accordingly. The redactions objects and the entity objects are similar to one another, and may be combined into a single field with an attendant ‘source’ label indicating whether the object is an entity or a redaction.

For the entity and redaction recognition the input includes the raw text, target and name information. The output is a sentence text with entity tokens replaced with labels, and a listing of the entities. Entities may include names, products, businesses/organizations, places, named events, phone numbers, email addresses and the like. Following the entity extraction the PII redaction may be performed. The output resulting is a redacted text, listing of sentence entities, subject text redacted, and subject text entity listings. Examples of data that may be redacted include email addresses, phone numbers, ages, credit card numbers, names, locations, IP addresses, MAC addresses, hardware IDs and the like.

The second model employed includes a recurrent neural network (RNN) which classifies intents at a paragraph level. The third model is a different RNN that classifies individual sentences into intents (at 1330). The sentence-level intents and paragraph-level intents share the taxonomy but have a distinct set of labels.

Lastly, a K-nearest neighbor algorithm is used on sentence representations to group them into semantically similar groups (at 1340). When a cluster of semantically similar groups is big enough, the system may train the corresponding RNN model for the groups and create a new sentence intent RNN network and add it the set of sentence intents if bias and variance are low (at 1350).

The outputs of each of the above models represent the state of the environment that is then shared with the agent in a reinforcement learning setting. The agent applies a policy to optimize for an objective reward and determine the action (at 1360). If the action cannot be determined with a suitable degree of confidence (at 1370), the process may institute an annotation procedure (at 1380).

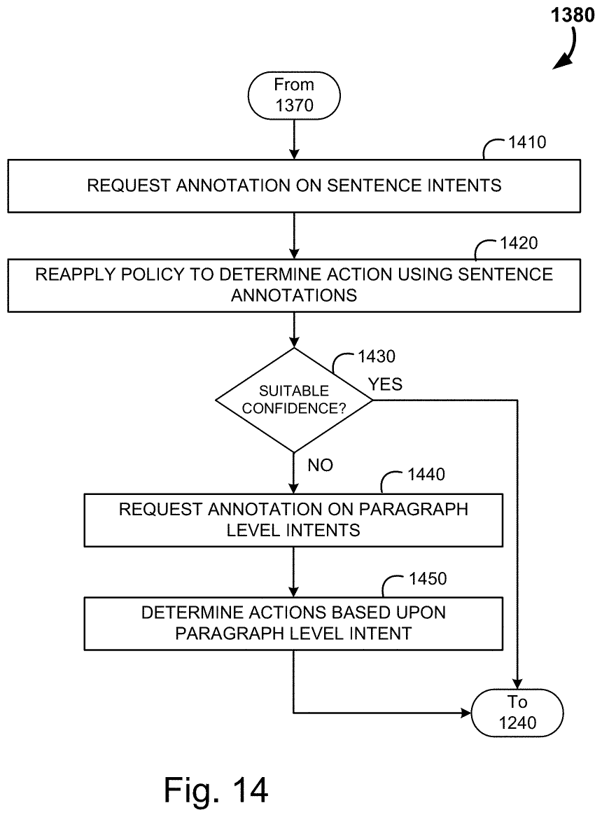

FIG. 14 provides a more detailed flow diagram of one example process for such annotations. Initially, annotations are requested at the sentence level (at 1410). Policies may be reapplied to determine the sentence intents using the newly added annotation information (at 1420). Again a check is made if the action can be determined with suitable confidence given the new sentence annotations (at 1430). If so, the annotation process may conclude, but if not then the system may request annotations on the paragraph level (at 1440). These paragraph level annotations are then leveraged to determine the intent on a less-granular paragraph level (at 1460). Annotations are organized into an annotation queue with an attendant priority setting. Annotations are then processed, in order of priority, by a human annotator, utilizing a web application annotation tool. The queue can be embodied as a SQL table, in some cases.

Annotations may include specific transition annotations, which require domain specific knowledge, are applicable to only the present exchange, but require less manual input. Annotations may also include annotation of intents and entity values. Such annotations do not require domain specific knowledge, are applicable across any exchange where these intents and entities are present, but require more manual input. The type of annotation desired may vary based upon if the use case is at a system level or at a client level, in some embodiments.

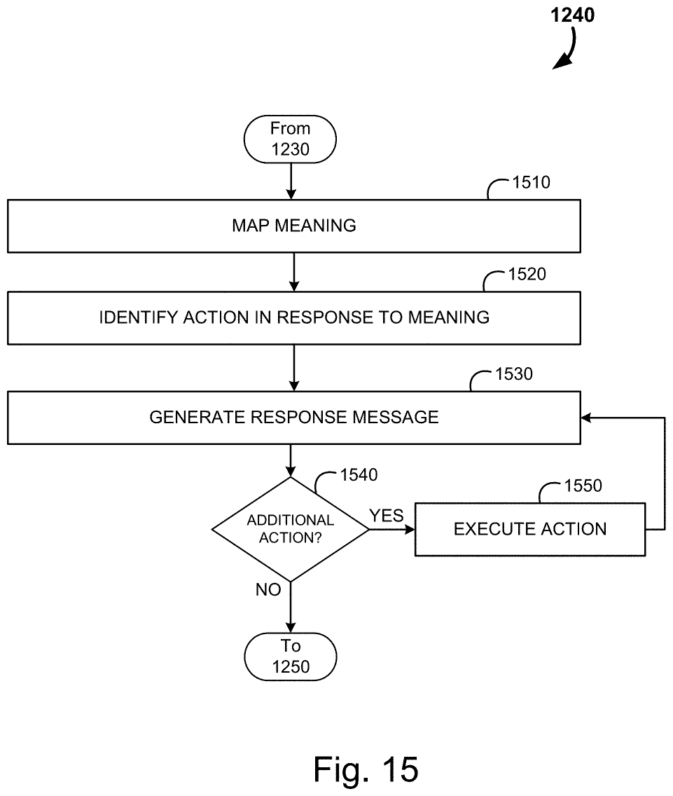

Returning to FIG. 12, after intent classification has been performed, actions may be set by application of business logic (policies) to the classification (at 1240) as touched upon in the earlier figures. This sub process is described in greater detail in relation to FIG. 15. A critical component of action determination is to map the intents predicted during classification to meanings (at 1510). The meaning or intent is then used to identify an action (at 1520) using a nested Boolean expression, hierarchy of intents, policy gradient algorithms such as A3C, value iteration algorithms such as Double Deep Q-Learning Networks, and other reinforcement learning algorithms (for sentence level intents). Paragraph level intents are fewer in number and may be mapped to actions using simple conjunctive or disjunctive Boolean expression without nesting.

This response is generated (at 1530) by identifying an appropriate response template, and populating the variable fields within the template. Population of the variable fields includes replacement of facts and entity fields from the conversation library based upon an inheritance hierarchy. The conversation library is curated and includes specific rules for inheritance along organization levels and degree of access. This results in the insertion of customer/industry specific values at specific place in the outgoing messages, as well as employing different lexica or jargon for different industries or clients. Wording and structure may also be influenced by defined conversation objectives and/or specific data or properties of the specific target.

Specific phrases may be selected based upon weighted outcomes (success ranks). The system calculates phrase relevance scores to determine the most relevant phrases given a lead state, sending template, and message component. Some (not all) of the attributes used to describe lead state are: the client, the conversation, the objective (primary versus secondary objective), series in the conversation, and attempt number in the series, insights, target language and target variables. For each message component, the builder filters (potentially thousands of) phrases to obtain a set of maximum-relevance candidates. In some embodiments, within this set of maximum-relevance candidates, a single phrase is randomly selected to satisfy a message component. As feedback is collected, phrase selection is impacted by phrase performance over time, as discussed previously. In some embodiments, every phrase selected for an outgoing message is logged. Sent phrases are aggregated into daily windows by Client, Conversation, Series, and Attempt. When a response is received, phrases in the last outgoing message are tagged as ‘engaged’. When a positive response triggers another outgoing message, the previous sent phrases are tagged as ‘continue’. The following metrics are aggregated into daily windows: total sent, total engaged, total continue, engage ratio, and continue ratio.

To impact message-building, phrase performance must be quantified and calculated for each phrase. This may be performed using the following equation:

$$Equation 1 \text{:} Phrase performance$$

$$performance = \frac{( percent\_engaged + percent\_continue )}{2}$$

Engagement and continuation percentages are gathered based on messages sent within the last 90 days, or some other predefined history period. Performance calculations enable performance-driven phrase selection. Relative scores within maximum-relevance phrases can be used to calculate a selection distribution in place of random distribution.

Phrase performance can fluctuate significantly when sending volume is low. To minimize error at low sending volumes,

$$a \frac{ln ( x )}{x}$$

padding window is applied to augment all phrase-performance scores. The padding is effectively zero when total_sent is larger than 1,500 sent messages. This padded performance is performed using the following equation:

$$Equation 2 \text{:} Padded performance$$

$$performance\_pad = 100 \times \frac{ln ( total\_sent + LN\_OFFSET )}{total\_sent + ZERO\_OFFSET}$$

Performance scores are augmented with the performance pad prior to calculating distribution weights using the following equation:

performance′=performance+performance_pad

### Equation 3: Augmented Phrase Performance

As noted, phrase performance may be calculated based on metrics gathered in the last 90 days. That window can change to alter selection behavior. Weighting of metrics may also be based on time. For example, metrics gathered in the last 30 days may be assigned a different weight than metrics gathered in the last 30-60 days. Weighting metrics based on time may affect selection behaviors as well. Phrases can be shared across client, conversation series, attempt, etc. It should be noted that alternate mechanisms for calculating phrase performance are also possible, such as King of the Hill or Reinforcement Learning, deep learning, etc.

Due to the fact that message attempt is correlated with engagement; metrics are gathered per attempt to avoid introducing engagement bias. Additionally, variable values can impact phrase performance; thus, calculating metrics per client is done to avoid introducing variable value bias.

Adding performance calculations to message building increases the amount of time to build a single message. System improvements are required to offset this additional time requirement. These may include caching performance data to minimize redundant database queries, aggregating performance data into windows larger than one day, and aggregating performance values to minimize calculations made at runtime.

In addition to performance-based selection, as discussed above, phrase selection may be influenced by the “personality” of the system for the given conversation. Personality of an AI assistant may not just be set, as discussed previously, but may likewise be learned using machine learning techniques that determines what personality traits are desirable to achieve a particular goal, or that generally has more favorable results.

Message phrase packages are constructed to be tone, cadence, and timbre consistent throughout, and are tagged with descriptions of these traits (professional, firm, casual, friendly, etc.), using standard methods from cognitive psychology. Additionally, in some embodiments, each phrase may include a matrix of metadata that quantifies the degree a particular phrase applies to each of the traits. The system will then map these traits to the correct set of descriptions of the phrase packages and enable the correct packages. This will allow customers or consultants to more easily get exactly the right Assistant personality (or conversation personality) for their company, particular target, and conversation. This may then be compared to the identity personality profile, and the phrases which are most similar to the personality may be preferentially chosen, in combination with the phrase performance metrics. A random element may additionally be incorporated in some circumstances to add phrase selection variability and/or continued phrase performance measurement accuracy. After phrase selection, the phrases replace the variables in the template. The completed templates are then output as a response. The system may determine if additional actions are needed (at 1540), which may include attaching documents, setting calendar appointments, inclusion of web hooks, or similar activities (at 1550).

Returning all the way back to FIG. 12, after the actions are generated, a determination is made whether there is an action conflict (at 1250). Manual review may be needed when such a conflict exists (at 1270). Otherwise, the actions may be executed by the system (at 1260).

Returning then to FIG. 10, after the response has been processed, a determination is made whether to deactivate the target (at 1075). Such a deactivation may be determined as needed when the target requests it. If so, then the target is deactivated (at 1090). If not, the process continues by determining if the conversation for the given target is complete (at 1080). The conversation may be completed when all objectives for the target have been met, or when there are no longer messages in the series that are applicable to the given target. Once the conversation is completed, the target may likewise be deactivated (at 1090).

However, if the conversation is not yet complete, the process may return to the delay period (at 1020) before preparing and sending out the next message in the series (at 1030). The process iterates in this manner until the target requests deactivation, or until all objectives are met. This concludes the main process for a comprehensive messaging conversation.

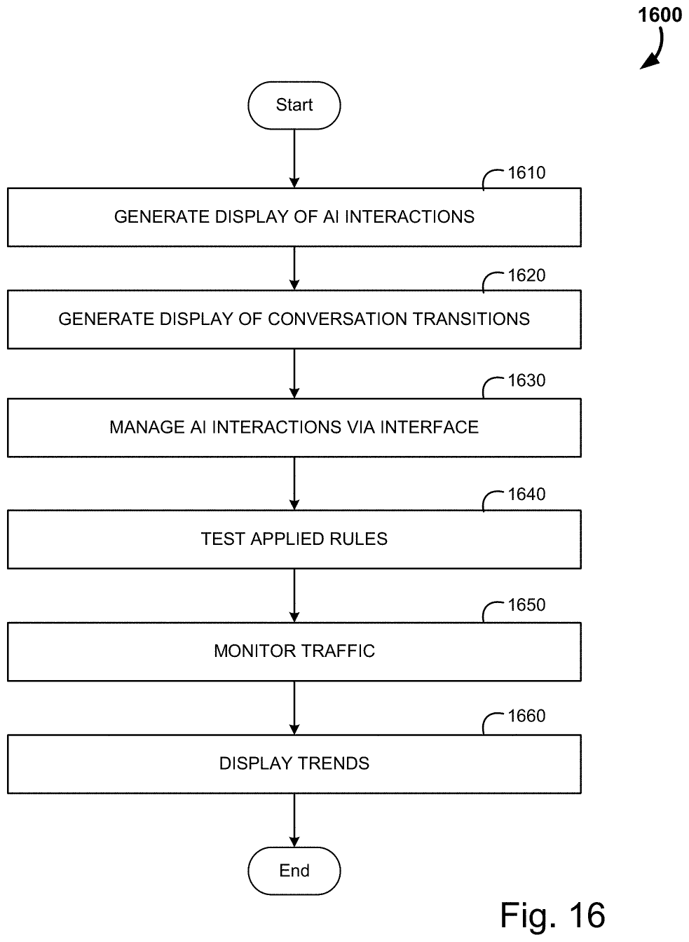

Turning now to FIG. 16, an example process flow diagram is provided for the method of AI interaction trend display, shown generally at 1600. As noted previously, the interactions between the AI systems and targets are of interest to the business clients that these AI systems are operating on behalf of This example process includes the design, display and management of these AI interactions. Initially the AI interactions are displayed (at 1610) in a manner that illustrates the flow of the conversation. This includes generating a table, where each column alternates from the AI assistant and the target. The initial column is the AI, and starts with an engagement node, which may result in the lead having one of seven possible responses (in this example). These response/actions may include: 1) indicating that they are the incorrect contact, but providing contact information, 2) indicating they desire to be called, with attendant contact information, 3)indicating they are the wrong contact, but not including contact information, 4) expressing confusion, 5) confirming interest, 6) stating they are not interested, and 7) asking to stop messaging.

For not interested and stop messaging responses, the conversation terminates. For wrong contact without contact information, at the next column the assistant may request contact information. This results in the following column with the target either providing contact information, not providing the information, or asking to stop messaging. If not information is provided or a stop messaging request is sent the conversation again ends. But for when contact information is provided the flow progresses to the next column where an acknowledgment is sent to the target and a follow-up activity is planned.

For a target expressing confusion the assistant may provide an explanation. Then in the next column the target may indicate no interest, to stop messaging or confirming interest. Again, lack of interest or a stop messaging request results in to a termination of the exchange. But confirmed interest proceeds to the same column where an acknowledgment is sent to the target and a follow-up activity is planned.

For a wrong contact but providing new contact information the flow may likewise skip forward to the column where an acknowledgment is sent to the target and a follow-up activity is planned. Similarly when the target asks to be called the flow may also skip forward to the column where an acknowledgment is sent to the target and a follow-up activity is planned.

For an initial confirmation of interest, the assistant may qualify the target, including collecting a phone number or additional piece of information. Then in the next column the target may indicate no interest, to stop messaging or confirming interest. Again, lack of interest or a stop messaging request results in to a termination of the exchange. But confirmed interest proceeds to the same column where an acknowledgment is sent to the target and a follow-up activity is planned.

Follow-up generally includes contact by a human representative or other mechanism for completing a sales event (in this example). In the column after following up by the assistant, the target may take a number of actions. These include eliciting a further action, indicating satisfaction, indicating that no additional action is needed, indicating dissatisfaction and to request stop messaging. Again stop messaging end the conversation, as does a dissatisfied response. No further action causes the assistant in the next column to send an acknowledgement that no additional action is needed. A satisfied response causes the assistant in the next column to send an acknowledgement directed to a satisfied target. Lastly, a further action response would cause the system to send an acknowledgement including what additional actions will be taken.

By graphically plotting this information out in this manner even a non-technically inclined user can easily understand the course or the conversation at any given junction, and when desired can alter the conversation flow. The above example may be well suited for situations where large ticket items are being sold to already interested individuals, such as in a car dealership situation. Other conversation flows may alternatively be desired for other use cases, and allowing these flows to be graphically displayed and altered can assist in configuring these flows accordingly.

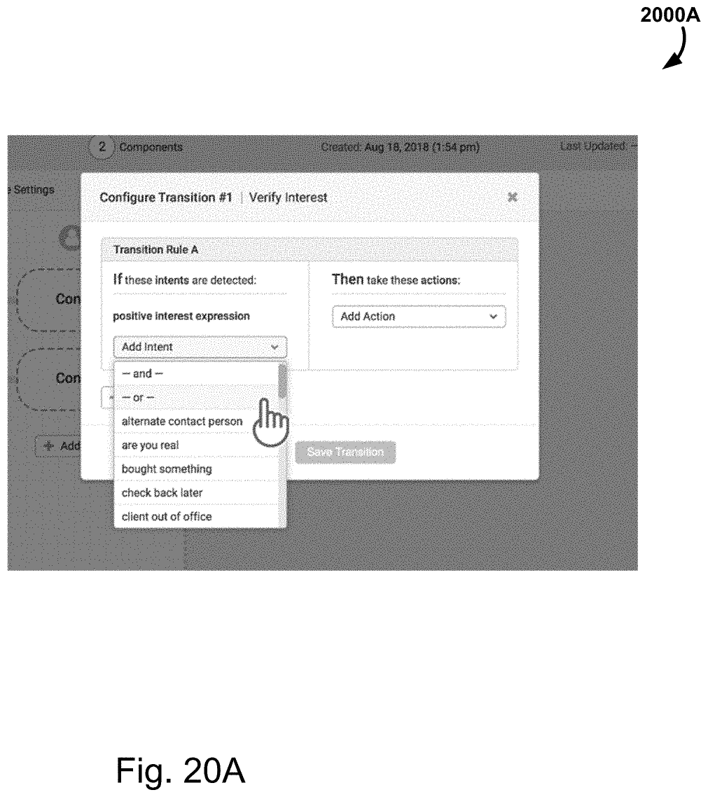

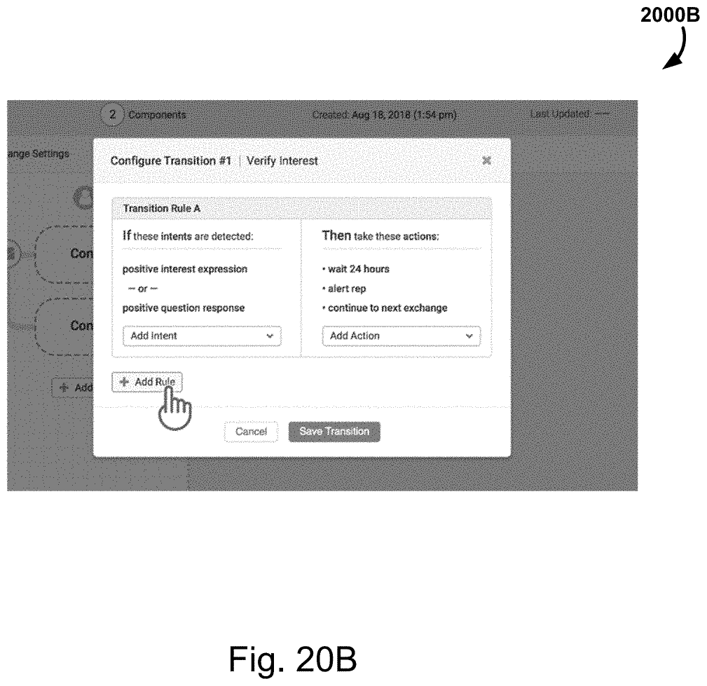

In addition to displaying the conversation flow, the system is capable of generating displays of conversation transition points (at 1620). Subsequently the interactions/transitions are manageable via this displayed interface (at 1630). FIG. 20A provides an example screenshot 2000A of this graphically displayed transition configuration. These take the form of basic “if-then” statements, where dropdown menus allow the user to select intents that can be grouped together in Boolean clusters and when detected particular actions are taken. In FIG. 20B the selection of rule elements is presented in the transition configuration interface, seen at 2000B. Here it may be seen that if a positive interest expression or a positive question is detected, the resulting action is to take 24 hours before alerting a representative and continuing to the following exchange, in this example.

Returning to FIG. 16, the next step is to test the applied rules (at 1640). This testing includes the application of the newly developed rules to either historical exchanges (to show how the AI response would have reacted differently), or via real-time response processing. In the real-time processing the rules may be applied to responses that are current to illustrate to the user how actions are determined. This allows the user to make a decision on the intended impact of the applied rules and fine tune them as desired. Additionally, the rules may be run in parallel with randomized samples of conversations versus other rule sets. This allows for true, blind A/B testing of rule sets. Given sufficient data, by analyzing the number of times business objectives are met in each testing group it can be determined which rule sets are actually more effective. If “true” A/B testing isn't desired, it is still possible to roll out the new rules and analyze conversation success in terms of conversion rates, engagement, or other factors against historical expectations. These comparisons won't eliminate macro variables that may be outside of the system's control (overall economy, weather, etc.) but may still provide useful information regarding the rule efficacy.

The process then monitors conversation traffic (at 1650) for intents that have been classified. Since possibly many millions (or even tens or even hundreds of millions) conversations are occurring simultaneously the ability to identify trends in these identified intents (at 1660) may be performed. These trends are then visualized, in real time, in terms of the intents being identified and additionally the actions being taken in response to these intents. These visualizations may be leveraged by the user to determine which rules would be beneficial to create, and which traffic transitions to manage. Additionally, this allows the targets to be treated differently by the “type” of respondent they are. For example, the targets may be bucketed into various groups, such as “hot leads” or “leads that require further action” based on response received. As substantial response data, intent trends and action data is being collected, it is possible to determine different intent/action rules that may be more effective for various targets based upon their group.

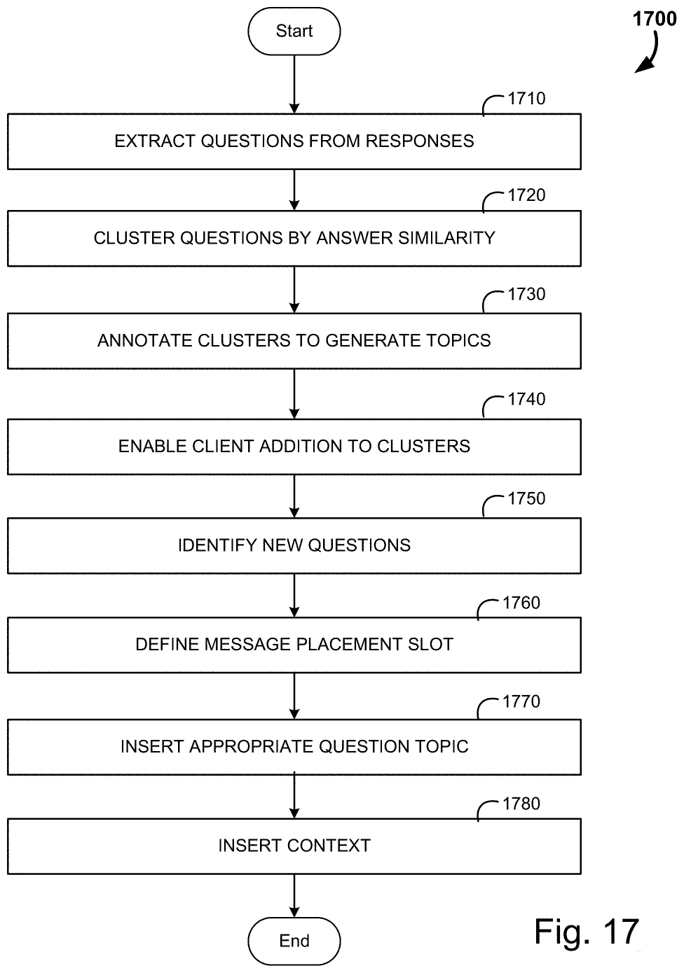

Turning now to FIG. 17, an example process flow diagram is provided for the method of automated FAQAA generation from conversational exchanges, shown generally at 1700. In this example process questions are automatically extracted from conversations responses (at 1710) using simple rule based analysis, or more complex NLP techniques disclosed herein. In some embodiments, the questions are clustered by their associated answers (at 1720) where questions that have semantically similar answers are clustered together. This approach has the benefit of reducing workloads on the client and allows the questions to be provided to the clients. Alternatively, as already discussed, topics which are annotated may be used for cluster generation (at 1730). Such reliance upon annotation allows more refined question clustering, but requires more human annotation input. This process initially merges the various topics into clusters, and then generates a refined list of questions for each cluster by matching the questions to these topics. Topics are determined initially by modeling techniques (which identified a probability that a given model has a particular topic). Annotators are then shown a “master question” per topic. This master question is a simple question that has the highest probability to be in the given topic. The annotators are then asked to see if the first topic master question is the same as the second topic master question. If so the topics may be merged. This occurs for all topic categories in an iterative loop until a final listing of discrete clusters are identified. Subsequently, the annotators are shown for each cluster all the questions that belong to the cluster one by one. The annotators use the master question in the cluster (still defined as the question that is modeled for the topic cluster with the highest probability) to compare against the other questions. The presented questions are then accepted or rejected based upon the annotator response.

Regardless of whether answer similarity clustering, annotator dependent topic clustering, or a combination thereof are used to determine the question clusters, the process allows the client to add questions to the cluster directly (at 1740). This is enabled using an interface that lists the clusters and allows for direct editing therein.

Subsequently, the new questions which have been identified are exposed to the client (at 1750) in order to allow a representative to answer the question. This answering allows the system to know how to react to future questions in the same category. This allows the generation of question/answer pairs automatically, which when approved by the client may be deployed to avoid involving a human representative in the future.

In addition to the automatic generation of question and answers, the process also enables graceful handling of a target's questions that still effectuates the system's goals when responding to the question with the identified approved answers. This integration of the answer with the next stage response in the conversation requires that the message placement slots are defined (at 1760). This placement slot is defined by the question type, conversation, client, client list, industry and global combination.

For example, in some embodiments, a user may ask a question of “what does your service do?” The answer for this question, in a series two conversation (stage where a meeting is requested in this example) may provide an answer to this question with no context directly after the salutation. This is then followed by the primary content of the message (e.g., a question regarding the target's availability to be reached at a given time at a specific contact number). In contrast, the exact same question may be answered differently in a series three conversation (follow-up after a meeting). In this example, after the salutation is an explanation of the reason for the email, a question on whether the representative had already contacted the target, and then the answer with an attendant context. In this example, the context could include a phrase such as “In response to your question about how the service works, <answer>.”

Appropriate ‘question topics’ are inserted (at 1770) as variables in the message template. Human administrators may be responsible for placement of these variables, or they may be inserted through the automated clustering of topic that is obtained. Context is inserted (at 1780) to determine where in the message the answer should be placed. In some cases, a pre-defined context will be present by default, but this context may be added or removed by the human administrators of the AI system based upon the question and conversation combination. For example, the default context is to immediately state “To answer your question about {question topic}. {Approved Question Answer}. {Remaining message content}.” However, for other question/conversation combinations it may be preferable to answer the question later in the message after the conversation message that relates to the objective is first addressed. This may be particularly true for questions that have a less than pleasant answer, or extremely trivial questions.

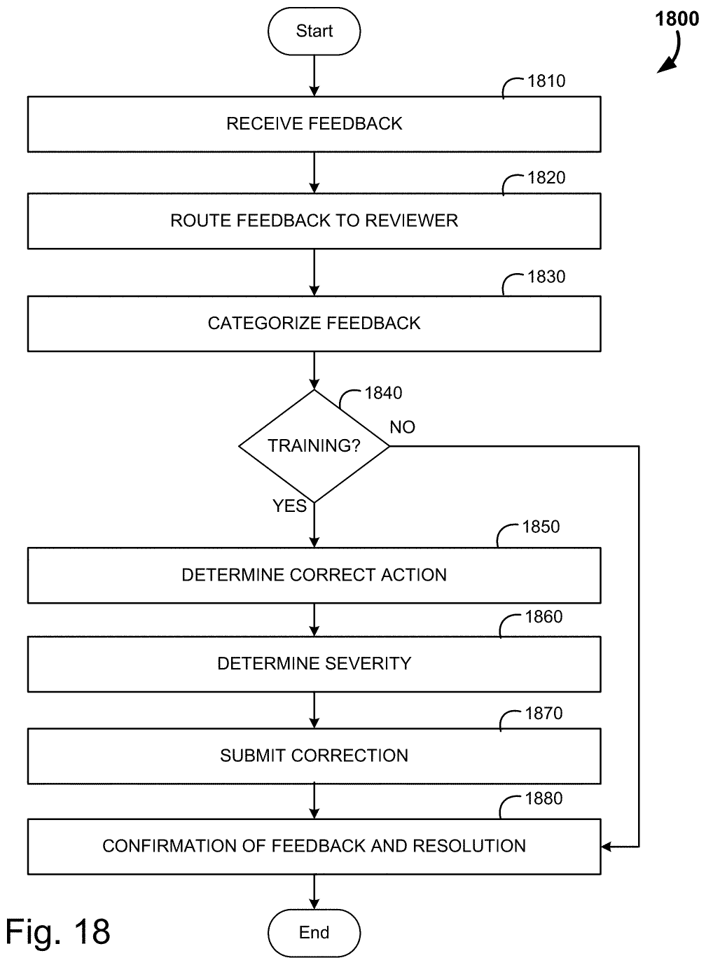

Turning now to FIG. 18, the process for feedback handling is described in greater detail, shown generally at 1800. Initially the feedback is received (at 1810). This may include a simple email feedback message, or may include a populated and structured feedback form. If emailed, the content thereof is reviewed and provided to the system in the structured format for consistent processing. The feedback is then routed to a reviewer (at 1820), which analyzes the response and operation of the AI system to determine why the action was taken. This is all used to categorize the feedback (at 1830) as either an error of the person reporting the feedback, a future feature that the current system has not yet deployed, proper operation of the AI system, or an actual error in need of training. A check is then made of the classification to see if training is needed (at 1840). If not, and it is any of the other three categories, the process may generate a confirmation of the feedback tailored to the feedback classification and resolve the feedback with the client (at 1880). However, if training was needed, the process instead determines the corrective action required (at 1850). This may include updating a rule if the intent was properly identified, but the action taken is not responsive to the intent. In contrast, the correction may entail model versioning, updating or new model deployment if instead the issue was a misclassification of the intent. Other corrective actions can include repairing errors in email templates, updating stale information in the knowledge database, and the like.

Subsequently, the severity of the mistake may be determined (at 1860). This may be determined by a qualitative determination by a human expert, or via a number of quantitative methods. For example, the expected monetary cost of the error can be statistically derived and used to measure error severity. In the case of classification error, systems similar to the Conversica Score discussed elsewhere in this document may be employed to ascertain the severity of the error. These methods take into account the business objectives of the client when determining how egregious an error was.

The correction may be tailored, at least in part, based upon the error's severity. Exceptionally erroneous classification may require new model deployment or reversion to an earlier version that does not have the error. Smaller errors in contrast may only require slight changes to model weights in order to correct the problem. A rule based error may include altering the rule, or even eliminating any connection between the classification and the erroneous action, again based upon severity. Regardless of the correction determined, it is then submitted for deployment (at 1870) and the effectiveness of the correction can be measured. This allows during the confirmation of the feedback (at 1880) that the client is informed how much of an improvement in the system's accuracy their feedback provided.

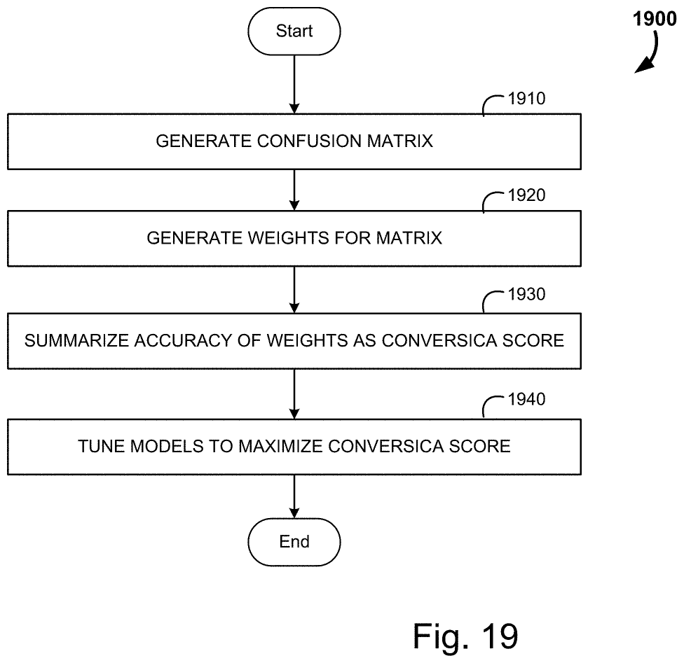

Turning now to FIG. 19, the process for determining a unified accuracy score (Conversica Score) is provided generally at 1900. This process starts with the generation of a confusion matrix (at 1910) which lists the ground truth for a response (as determined by annotator review) along one axis of the matrix, and the predicted classification by the AI model along the other axis. This results with the frequency of the probability that the classification is correct along the diagonal axis, and the chances of a misclassification in the other matrix cells.

Subsequently, weights are generated for the matrix (at 1920) which take into account the business objectives of the client, and the impact that this form of misclassification has on the business. For example ignoring requests for stopping messaging is liable to anger the target, at a minimum, and may even run afoul of privacy and nuisance laws depending upon the jurisdiction. Thus, any misclassification of a stop messaging request will typically have a relatively large weight as compared to say misclassifying an expression of confusion as a desire for more information. As noted before, another way to determine weights is to statistically link the monetary cost to the client for the given misclassification.

The weights may be applied to the probabilities of misclassification in the confusion matrix to generate a set of values indicating component severity/accuracy errors of the model which may be aggregated using the formula provided previously to generate the consolidated Conversica Score (at 1930). Then, when the models are being trained/tuned the impact the changes have on the Conversica Score is ascertained. Model variables may be iteratively tested in an attempt to maximize the Conversica Score, not in order to necessarily make the model more accurate in a traditional sense, but rather to ensure that the severity of all resulting errors that do occur is reduced (a function of error frequency in combination with error severity).

### III. System Embodiments

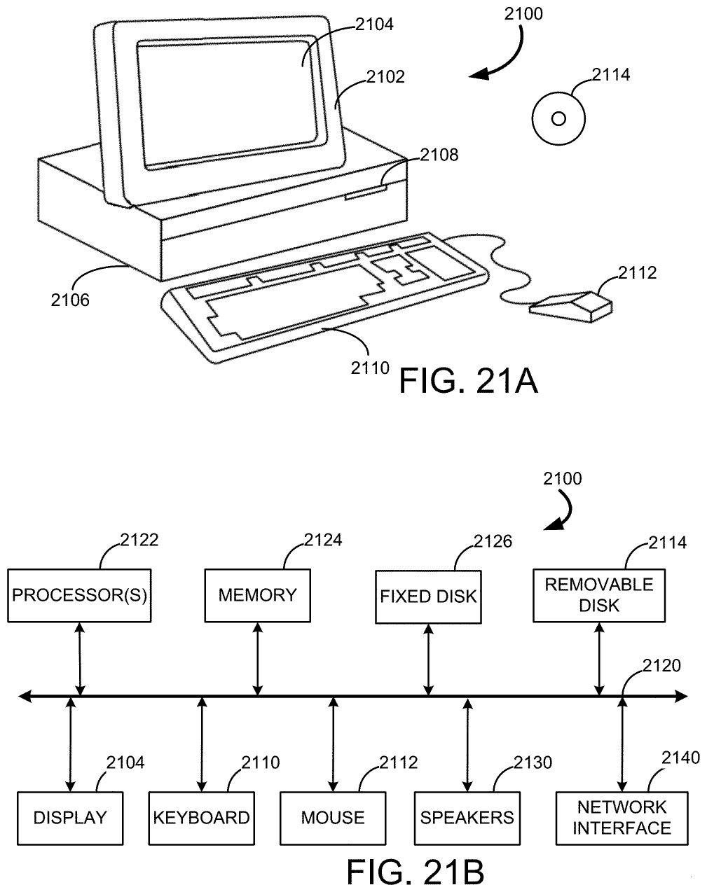

Now that the systems and methods for the conversation generation with improved functionalities have been described, attention shall now be focused upon systems capable of executing the above functions. To facilitate this discussion, FIGS. 21A and 21B illustrate a Computer System 2100, which is suitable for implementing embodiments of the present invention. FIG. 21A shows one possible physical form of the Computer System 2100. Of course, the Computer System 2100 may have many physical forms ranging from a printed circuit board, an integrated circuit, and a small handheld device up to a huge super computer. Computer system 2100 may include a Monitor 2102, a Display 2104, a Housing 2106, a Storage Drive 2108, a Keyboard 2110, and a Mouse 2112. Storage 2114 is a computer-readable medium used to transfer data to and from Computer System 2100.

FIG. 21B is an example of a block diagram for Computer System 2100. Attached to System Bus 2120 are a wide variety of subsystems. Processor(s) 2122 (also referred to as central processing units, or CPUs) are coupled to storage devices, including Memory 2124. Memory 2124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Storage 2126 may also be coupled bi-directionally to the Processor 2122; it provides additional data storage capacity and may also include any of the computer-readable media described below. Fixed Storage 2126 may be used to store programs, data, and the like and is typically a secondary storage medium (such as a hard disk) that is slower than primary storage. It will be appreciated that the information retained within Fixed Storage 2126 may, in appropriate cases, be incorporated in standard fashion as virtual memory in Memory 2124. Removable Storage 2114 may take the form of any of the computer-readable media described below.

Processor 2122 is also coupled to a variety of input/output devices, such as Display 2104, Keyboard 2110, Mouse 2112 and Speakers 2130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2122 optionally may be coupled to another computer or telecommunications network using Network Interface 2140. With such a Network Interface 2140, it is contemplated that the Processor 2122 might receive information from the network or might output information to the network in the course of performing the above-described dynamic messaging processes. Furthermore, method embodiments of the present invention may execute solely upon Processor 2122 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2100 can be controlled by operating system software that includes a file management system, such as a storage operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for generating a display of AI interactions in an automated conversation comprising:
generating a series of columns alternating between an AI and a target, wherein the first column is for the AI;
placing a first node in the first column, wherein the first node is engaging the target;
populating following columns in the series with a plurality of nodes, wherein the nodes include both termination response types and continued contact types; and
coupling each continued contact type node from each column to at least one node in a later column.

2. The method of claim 1, wherein the termination response types include stop messaging, not interested, and dissatisfied.

3. The method of claim 1, wherein the continued contact types include contact information provided, confirm interest, further action, no further action and satisfied.

4. A method for managing AI transactions in an automated conversation comprising:
generating an interface for configuring a transition including a pull down menu of detected intents, and a pulldown menu of attendant actions;
receiving selections of at least one intent and at least one action component, where multiple intents are separated by either an ‘and’ or an ‘or’; and
adding the selections as a rule

5. The method of claim 4, further comprising testing the rule.

6. The method of claim 5, wherein the testing is concurrent A/B testing with earlier rules.

7. The method of claim 5, wherein the testing is comparison of the rule to historical response data to determine actions.

8. The method of claim 5, wherein the testing is applying the rule in real time and comparing the results to expected results.

9. The method of claim 5, wherein the testing is measured against at least one business objective.

10. The method of claim 4, wherein the rule is applied in real time.

11. The method of claim 10, wherein impact of the rule application is visualized along with responses the rule is applied to.

12. The method of claim 11, further comprising tuning the rule in response to the visualization.

13. A method for visualizing trends in automated conversations comprising:
administering a plurality of concurrent AI driven artificial conversations;
classifying responses in the plurality of conversations to determine intents;
quantifying the intents at a given time;
identifying trends in intent and conversation volume; and
displaying the trends.

14. The method of claim 13, wherein the plurality is in excess of a million concurrent AI driven artificial conversations.
